(19) United States
(12) Patent Application Publication
(10) Pub. No.: US 2017/0358028 A1
(43) Pub. Date: Dec. 14, 2017

(54) FINANCIAL PRODUCT TRADING SYSTEM, METHOD OF TRADING FINANCIAL PRODUCT, COMMUNICATION TERMINAL, SERVER, COMPUTER PROGRAM AND SERVER COMPUTER PROGRAM

(71) Applicant: One Tap BUY Co., LTD., Tokyo (JP)

(72) Inventor: Kazuto Hayashi, Tokyo (JP)

(21) Appl. No.: 15/540,694

(22) PCT Filed: Jan. 5, 2015
(86) PCT No.: PCT/JP2015/050068

§ 371 Date: Jun. 29, 2017

(51) Int. Cl. G06Q 40/04; G06F 3/0481; G06Q 30/06; G06Q 40/06

(52) U.S. Cl. CPC G06Q 40/04; G06Q 40/06; G06F 3/04817; G06Q 30/0643

(57) ABSTRACT

A specified brand trade screen where a buy/sell transaction of a particular brand is performed is displayed on a user terminal which is used by an investor (user) for an online stock trade. In the specified brand trade screen, a selectable profit-portion sell button is arranged when a sell button is selected and the screen changes into a sell transaction state. When the profit-portion sell button is selected by the user, the user terminal transmits a sell instruction for a profit portion of the particular brand according to the currently-displayed specified brand trade screen, to a securities company system. When the securities company system receives the sell instruction for the profit portion, it calculates the profit portion of the user for the particular brand, identifies the number of stocks corresponding to the calculated profit portion, and performs a sell transaction based on the identified number of stocks.

### TECHNICAL FIELD

The present invention relates to a financial product trading system, a method of trading a financial product, a communication terminal, a server, a computer program, and a server computer program, that enable a user who is an investor to perform a sales transaction of a financial product remotely through a network using the communication terminal to access the server which is managed by a company which provides a trading service of the financial product, such as a securities company, and specifically enables the user to easily send a sell instruction of the financial product with a one-touch operation to the securities company, etc. by making a trade instruction of the user a routine.

### BACKGROUND ART

Conventionally, services which enable investors to perform sales transactions of financial products, such as stocks, online by using communication terminals, such as computers, smartphones, and cellular phones having a communicating function are widely used in the public. In stock trades by online, a transaction screen where a selection of a brand, a decision of an investment value, etc. take place is presented to a communication terminal of an investor (user).

Although it is common in a stock sales transaction to perform a trade by a unit of the number of stocks in which the number of stocks is specified, services in which a trade is performed by a unit of money amount which specifies the sales money amount (specified-by-money-amount) are also provided (see [0009] of Patent Document 1 listed below, [0008] of Patent Document 2 listed below, and [0041] of Patent Document 3 listed below, etc.).

Moreover, Patent Document 4 listed below discloses a method in which, in order to trade stocks of a certain company, an icon for the company is displayed on a home screen of a mobile terminal and when the icon is selected, an IR application which provides IR information, etc. of the company is activated, and the IR application is provided with a function to perform a stock trade of the company (see [0025], [0060], etc. of Patent Document 4). Moreover, Patent Document 5 listed below discloses a method in which, when selecting a brand for a sales transaction, a desired brand is able to be specified among a list screen of searched brands using a menu screen (see [0018], FIG. 4, etc. of Patent Document 5).

Further, in recent years, a service in which a sales transaction has been automatically executed if a brand satisfies a certain condition is provided (a system trade, which is often referred to as “Sys-Tre”). As one example of contents set in the system trade, Patent Document 6 listed below discloses a method in which, when profit occurs, the profit is allotted for a purchase in the subsequent cycle (see [0156], etc. of Patent Document 6), and Patent Document 7 listed below discloses a method in which realized profit is put into a money pool for reinvestment (see [0026], etc. of Patent Document 7).

### REFERENCE DOCUMENTS OF CONVENTIONAL ART

### Patent Documents

### Patent Document 1: JP2004-302745A

### Patent Document 2: JP2004-029882A

### Patent Document 3: JP2004-234140A

### Patent Document 4: JP2014-130488A

### Patent Document 5: JP1996-263558A

### Patent Document 6: JP2009-237742A

### Patent Document 7: JP2010-055186A

### DISCLOSURE OF THE INVENTION

### Problems to be Solved by the Invention

In case where a user sells by an online trade system, if it is a trade by a unit of the number of stocks, the user needs to specify the number of stocks to sell, and if it is a trade by a unit of money amount, the user needs to specify a money amount to sell. Thus, the user has to thoroughly think of the number of stocks or the money amount to be set, and a problem in which it is difficult to smoothly give a sell instruction (sell order) arises. In addition, when the user is trying to quickly give an instruction, the users feel that the specifying operation of the number of stocks or the money amount is troublesome. Note that although Patent Documents 6 or 7 described above discloses allotting the profit for the purchase to the subsequent cycle, or putting the realized profit into the pool for reinvestment, these methods are directed to the system trade. They cannot be used for trades based on user operations as they are. Moreover, since the methods of Patent Documents 6 and 7 allot the profit to the buy transaction, they are fundamentally different from a transaction to sell only stocks corresponding to the profit.

Moreover, in the online trade system, the selection of brand to be traded must be determined by the user. In the conventional system, as disclosed in Patent Document 5 listed above, since brands retrieved from numerous brands by a search are displayed in the form of a list screen, the search, etc. is needed. Therefore, the brand selection (specification) takes time and effort, leading to a factor that obstructs quick trade instruction. Note that although the method of Patent Document 4 allows the user to perform a trade of stocks of a certain particular company by selecting an icon, the user cannot select his/her desired brands for trading from a plurality of brands because only the certain particular company is able to be traded.

The present invention is made in view of such situations, and provides a financial product trading system, a method of trading a financial product, a communication terminal, a server, a computer program, and a server computer program, which are configured to display a transaction screen containing an operating part corresponding to routine sell instructions so that a sell instruction can be given smoothly, and allow a user to give, with a one-touch operation, a routine sell instruction, such as “sell for only profit portion,” “sell all possessed,” and “sell by a unit of a given number.”

Moreover, the present invention provides a financial product trading system, a method of trading a financial product, a communication terminal, a server, a computer program, and a server computer program, which are configured to display an icon screen where icons corresponding to a plurality of brands extracted beforehand are contained in the same screen to display the screen where a trade for a desired brand can be performed only by selecting an icon.

### SUMMARY OF THE INVENTION

In order to solve the issues described above, in a financial product trading system in accordance with one aspect of the present invention, a communication terminal transmits a trade instruction of a financial product to a server based on a user operation, and the server performs a transaction of the financial product in response to a reception of the trade instruction from the communication terminal. The communication terminal includes a display processor configured to display a transaction screen containing a sell-for-profit-portion operating part receivable of a user operation corresponding to a sell instruction for a profit portion resulted from the financial product of one particular brand, and a transmission processor configured to transmit the sell instruction for the profit portion resulted from the financial product of one particular brand to the server, when the user operation is received by the sell-for-profit-portion operating part. The server includes a transaction processor configured to perform, when the sell instruction for the profit portion resulted from the financial product of the one particular brand is received, a sell transaction for the profit portion resulted from the financial product of the one brand.

In the financial product trading system in accordance with the aspect of the present invention, the transaction screen may be a screen dedicated to the transaction of the one particular brand.

Further, in the financial product trading system in accordance with the aspect of the present invention, the server may include a trade history database configured to store a trade history of the financial product, an identification processor configured to identify, when the sell instruction for the profit portion resulted from the financial product of one particular brand is received, a unit price of the financial product of one particular brand at the moment of reception, a calculation processor configured to calculate the profit portion resulted from the financial product of one particular brand based on the trade history of the financial product of one particular brand stored in the trade history database and the identified unit price, and a transaction processor configured to perform a sell transaction for the calculated profit portion.

In the financial product trading system in accordance with the aspect of the present invention, the server may include a trade history database configured to store a trade history of the financial product, an identification processor configured to identify, when the sell instruction for the profit portion resulted from the financial product of one particular brand is received, a unit price of the financial product of the one brand at the moment of reception, a calculation processor configured to calculate the profit portion resulted from the financial product of the one particular brand based on the trade history of the financial product of the one brand stored in the trade history database and the identified unit price, and a transmission processor configured to transmit profit-portion information indicative of the calculated profit portion to the communication terminal. The communication terminal may include a display processor configured to display, when the profit-portion information is received, a confirmation screen that indicates the profit portion according to the received profit-portion information, and includes a sell confirmation operating part receivable of a user operation corresponding to a decided instruction of the selling for the profit portion, and a transmission processor configured to transmit the decided instruction to the sell instruction for the profit portion to the server, when the user operation is received by the sell confirmation operating part. The server may further include a transaction processor configured to perform a sell transaction for the calculated profit portion when the decided instruction is received.

In the financial product trading system in accordance with the aspect of the present invention, the communication terminal may include an acquisition processor configured to acquire a unit price of the financial product of one particular brand, a storing processor configured to store transaction data indicative of transaction details for the financial product of the one particular brand, a calculation processor configured to calculate the profit portion based on the acquired unit price and the stored transaction data, when the user operation is received by the sell-for-profit-portion operating part, a calculation processor configured to calculate the number of financial products of the one particular brand to be traded for the calculated profit portion based on the calculated profit portion and the unit price, and a transmission processor configured to transmit a sell instruction for the profit portion resulted from the financial product of the one particular brand to the server, the sell instruction including the information indicative of the calculated number of financial products to be traded. The server may include a transaction processor configured to perform, when the sell instruction for the profit portion resulted from the financial product of one particular brand is received, a sell transaction for the profit portion based on the information indicative of the number of financial products to be traded contained in the received sell instruction.

In a method of trading a financial product in accordance with another aspect of the present invention, a communication terminal transmits a trade instruction of a financial product to a server based on a user operation, and the server performs a transaction of the financial product in response to a reception of the trade instruction from the communication terminal. The communication terminal includes displaying a transaction screen containing a sell-for-profit-portion operating part receivable of a user operation corresponding to a sell instruction for a profit portion resulted from the financial product of one particular brand, and transmitting the sell instruction for the profit portion resulted from the financial product of one particular brand to the server, when the user operation is received by the sell-for-profit-portion operating part. The server includes performing, when the sell instruction for the profit portion resulted from the financial product of one particular brand is received, a sell transaction for the profit portion resulted from the financial product of the one brand.

A communication terminal in accordance with another aspect of the present invention transmits a trade instruction of a financial product based on a user operation to an external server. The communication terminal includes a display processor configured to display a transaction screen containing a sell-for-profit-portion operating part receivable of a user operation corresponding to a sell instruction for a profit portion resulted from the financial product of one particular brand, and a transmission processor configured to transmit the sell instruction for the profit portion resulted from the financial product of one particular brand to the external server, when the user operation is received by the sell-for-profit-portion operating part.

In the communication terminal in accordance with the aspect of the present invention, the transaction screen may be a screen dedicated to the transaction of the one particular brand.

Further, the communication terminal in accordance with the aspect of the present invention may include a display processor configured to display an icon screen containing selectable icons corresponding to a plurality of brands in the same screen, the plurality of brands being extracted beforehand, and a display processor configured to display, when a selection of one icon among the plurality of icons contained in the displayed icon screen is received, the transaction screen as a screen dedicated to a transaction of the one brand corresponding to the icon that received the selection.

In the communication terminal in accordance with the aspect of the present invention, the transaction screen may contain a sell-all operating part receivable of a user operation corresponding to a sell instruction for all the financial product of the one particular brand possessed by the user. The communication terminal may include a transmission processor configured to transmit, when the user operation is received by the sell-all operating part, a sell instruction for all the financial product of the one particular brand possessed by the user, to the external server.

In the communication terminal in accordance with the aspect of the present invention, the transaction screen may contain a money-amount setting part settable of a money amount by a unit of money amount of which at least a first digit is 0, and a sell-for-money-amount operating part receivable of a user operation corresponding to a sell instruction for the money amount set in the money-amount setting part for the financial product of the one particular brand. The communication terminal may include a transmission processor configured to transmit, when the user operation is received by the sell-for-money-amount operating part, a sell instruction for the money amount set in the money-amount setting part for the financial product of the one particular brand, to the external server.

The communication terminal in accordance with the aspect of the present invention may further include an acquisition processor configured to acquire an average buy unit price of the user of the financial product of one particular brand, or a latest unit price of the financial product of one particular brand, the transaction screen containing the acquired average buy unit price or the latest unit price.

The communication terminal in accordance with the aspect of the present invention may include an acquisition processor configured to acquire a total investment amount of the user for the financial product of the one particular brand, or a latest market value for the financial product of the one particular brand possessed by the user, the transaction screen containing the acquired total investment amount of the user or the latest market value for the user's possession.

Further, the communication terminal in accordance with the aspect of the present invention may include an acquisition processor configured to acquire a profit-and-loss of the user of the financial product of the one particular brand, the transaction screen containing the acquired profit-and-loss.

In a method of trading a financial product in accordance with another aspect of the present invention, a communication terminal transmits a trade instruction of a financial product based on a user operation to an external server. The communication terminal includes displaying a transaction screen containing a sell-for-profit-portion operating part receivable of a user operation corresponding to a sell instruction for a profit portion resulted from the financial product of one particular brand, and transmitting the sell instruction for the profit portion resulted from the financial product of the one particular brand to the external server, when the user operation is received by the sell-for-profit-portion operating part.

A server in accordance with another aspect of the present invention performs a transaction of a financial product in response to a reception of a trade instruction of the financial product transmitted from an external communication terminal. The server includes a transaction processor configured to perform, when a sell instruction for a profit portion resulted from the financial product of one particular brand is received from the external communication terminal, a sell transaction for the profit portion resulted from the financial product of the one brand.

In a method of trading a financial product in accordance with another aspect of the present invention, a server performs a transaction of the financial product in response to a reception of a trade instruction of the financial product transmitted from an external communication terminal. The server includes performing, when a sell instruction for a profit portion resulted from the financial product of one particular brand is received from the external communication terminal, a sell transaction for the profit portion resulted from the financial product of the one particular brand.

A computer program in accordance with another aspect of the present invention causes a computer including a communicating device to transmit a trade instruction of a financial product based on a user operation to an external server. The computer program causes the computer to display a transaction screen containing a sell-for-profit-portion operating part receivable of a user operation corresponding to a sell instruction for a profit portion resulted from the financial product of one particular brand, and transmit the sell instruction for the profit portion resulted from the financial product of the one particular brand to the external server by using the communicating device, when the user operation is received by the sell-for-profit-portion operating part.

A server computer program in accordance with another aspect of the present invention causes a server computer to perform a transaction of a financial product in response to a reception of a trade instruction of the financial product transmitted from an external communication terminal. The server computer program causes the server computer to perform, when a sell instruction for a profit portion resulted from the financial product of one particular brand is received from the external communication terminal, a sell transaction for the profit portion resulted from the financial product of the one particular brand.

In the present invention, a specified brand trade screen containing the sell-for-profit-portion operating part receivable of the user operation according to the sell instruction for the profit portion is displayed, and when the user operation is received by the sell-for-profit-portion operating part, the sell instruction for the profit portion resulted from the financial product of the one particular brand is transmitted to the server. Therefore, the sell instruction can be given with a one-touch operation of the sell-for-profit-portion operating part, and the user can conduct the sell transaction smoothly. The financial products in the present invention are those containing “securities” and “derivatives (financial derivatives)”, and as examples of the “securities,” there are stocks, bonds, real estate securities, securities of investment trusts, etc., and as examples of the “derivatives (financial derivatives),” there are futures transactions, CFDs (Contracts for Difference), and rights to subscribe for new shares. Moreover, the present invention is applicable to both the bilateral transactions and the brokerage transactions by the securities company, etc.

In the present invention, the transaction screen is the screen dedicated to the transaction of the one particular brand. Therefore, when the transaction screen is displayed, the user can concentrate on making a decision on the transaction of the one particular brand, and it can contribute to increasing the concentration of the user for making the decision on the transaction.

Moreover, in the present invention, the icon screen containing the selectable icons corresponding to the plurality of brands, which are extracted beforehand, is displayed in the same screen, and when one icon is selected by the user from the plurality of icons contained in the displayed icon screen, the transaction screen dedicated to the transaction for the one brand corresponding to the selected icon is displayed. Therefore, the selection of the icon also serves as the specification of the brand to be traded, and it can contribute to smoothly guide the screen contents to the transaction screen of the one particular brand to quickly conduct the transaction.

In the present invention, when the server including the trade history database receives the sell instruction for the profit portion resulted from the financial product of the one particular brand, the server identifies the unit price of the financial product of the particular brand, calculates the profit portion of the user who gave the sell instruction (the profit portion resulted from the financial product of the one particular brand) based on the identified unit price and the information stored in trade history database, etc., and performs the sell transaction for the calculated profit portion. Therefore, the user only gives the sell instruction for the profit portion, and the rest will be automatic so that the user can quickly complete the sell transaction for the profit portion.

In the present invention, when the server including the trade history database receives the sell instruction for the profit portion resulted from the financial product of the one particular brand, the server identifies the unit price of the financial product of the particular brand, calculates the profit portion of the user who gave the sell instruction (the profit portion for the financial product of the one particular brand) based on the identified unit price and the information stored in the trade history database, etc., and transmits the profit-portion information indicative of the calculated profit portion to the communication terminal of the user side. The communication terminal displays the confirmation screen indicative of the profit of the received profit-portion information. Therefore, an opportunity to confirm the concrete details of the profit portion can be presented to the user. Moreover, since the displayed confirmation screen contains the sell confirmation operating part, the user can give, after checking the concrete details of the profit portion, the instruction for finally deciding the sell instruction for the profit portion based on the checked contents. Therefore, the sell transaction for the profit portion is possible to be proceeded after obtaining the confirmation of the user, and a secure sell transaction is achieved.

In the present invention, the communication terminal on the user side includes the acquisition processor configured to acquire the unit price of the financial product of the one particular brand, the storing processor configured to store the transaction data indicative of the transaction details for the financial product of the one particular brand. When the user operation is received by the sell-for-profit-portion operating part of the communication terminal, the profit portion is calculated, the number of financial products to be traded corresponding to the calculated profit portion is also calculated, and the sell instruction for the profit portion containing the calculated number of financial products to be traded is transmitted to the server. The server side is released from the calculation for the profit portion, etc., and can perform the sell transaction similar to the conventional case of the sell instruction by the unit of stocks, etc. Thus, the server side can perform the sell transaction for the profit portion while suppressing an increase in the burden of processing on the server side.

In the present invention, the communication terminal on the user side displays the transaction screen containing the sell-all operating part in addition to the sell-for-profit-portion operating part described above. Therefore, other than selling only for the profit portion, the user side can give, by the one-touch operation, the instruction for selling all he/she possesses for the one brand if the respective operating parts are selected, and can smoothly give the sell instruction while ensuring the two kinds of routine sell instructions details.

In the present invention, in addition to the sell-for-profit-portion operating part described above, the communication terminal of the user side displays the transaction screen containing the money-amount setting part where the setting of the money amount is possible by the unit of money amount of which at least the first digit is 0, and the sell-for-money-amount operating part receivable of the user operation corresponding to the sell instruction for the money amount setting. Therefore, other than the selling only for the profit portion, the user side can quickly give the instruction for selling by the unit of money amount of which at least the first digit is 0 by selecting the respective operating parts, and the details of the sell instruction of the user can also be expanded while securing the situation where the quick sell instruction can be given, so that it is easier to be applied to the sell instruction reflecting the user's various intentions. Note that as the financial product dealt in the present invention, those of every country in the world are applicable, and therefore, kinds of currency to be the candidates for setting in the money-amount setting part may be currencies of every country in the world.

In the present invention, the communication terminal including the acquisition processor configured to acquire the average buy unit price or the latest unit price displays the transaction screen containing the acquired average buy unit price or the latest unit price. Therefore, materials for determining whether the user performs the sell instruction can be presented in the same screen as the screen where the operation of the sell instruction is performed, and thus, it is useful for the user smoothly performing a series of processing steps of giving the sell instruction (sell order).

In the present invention, the communication terminal on the user side including the acquisition processor configured to acquire the total investment amount for the one particular brand or the latest market value for the one particular brand displays the transaction screen containing the acquired total investment amount or the latest market value. The index for determining whether the user gives the sell instruction for the profit portion resulted from the transaction of the financial product of the one particular brand can be presented in the same screen as the screen where the sell instruction is given, and thus, it is useful for performing the quick sell order.

In the present invention, the communication terminal including the acquisition processor configured to acquire the profit-and-loss resulted from the transaction of the financial product of the one particular brand displays the transaction screen containing the acquired profit-and-loss. Therefore, the displayed profit-and-loss can be used, as the index for determining whether to give the sell instruction for the profit portion and since especially the profit-and-loss is arranged in the same screen as the operating part to give the sell instruction, it is useful for making a quick determination by the user.

### Effects of the Invention

In the present invention, since the transaction screen containing the sell-for-profit-portion operating part receivable of the user operation according to the sell instruction for the profit portion can be displayed on the communication terminal on the user side, the sell instruction for the profit portion can be given with the one-touch operation, and a quicker sell transaction is achieved compared with the conventional online trade system by presenting the routine sell transaction form for selling only the profit portion to the user.

In the present invention, the transaction screen is configured to be the screen dedicated to the transaction of the one particular brand. Therefore, when the transaction screen is displayed, the user can concentrate on the decision making on the transaction of the one particular brand, and it is useful for increasing the concentration level of the user when making the decision on the transaction.

Moreover, in the present invention, the icon screen containing in the same screen the selectable icons corresponding to the plurality of brands, which are extracted beforehand, is displayed. When the user selects one icon of the plurality of icons contained in the icon screen, the transaction screen dedicated to the transaction of the one brand corresponding to the selected icon is displayed. Therefore, the brand to be traded can be specified by th+++e selection of the icon.

In the present invention, when the server side receives the sell instruction for the profit portion resulted from the financial product of the one particular brand, the server calculates the profit portion of the user resulted from the financial product of the particular brand and performs the sell transaction for the calculated profit portion. Therefore, the user side only gives the sell instruction only for the profit portion, and the processing according to such a sell instruction can quickly be completed automatically.

In the present invention, when the user side gives the sell instruction for the profit portion, the server side calculates the concrete details for the profit portion according to the sell instruction, and presents the calculated concrete details and the operating part for confirming the final sell instruction to the communication terminal on the user side. Therefore, the opportunity for finally determining whether to decide the sell instruction can be presented to the user. Thereby providing the transaction form which focuses on certainly reflecting the user's intention.

In the present invention, when the communication terminal on the user side receives the sell instruction for the profit portion, the server calculates the details of the profit portion according to the sell instruction, and calculates the number of financial products to be traded corresponding to the calculated profit portion, and transmits the sell instruction for the profit portion containing the calculated number of financial products to be traded to the server. Therefore, the server side is only necessary to perform the sell transaction according to the number of financial products to be traded contained in the sell instruction, and thus the transaction for selling only the profit portion is achieved while reducing the processing burden on the server side.

In the present invention, the communication terminal on the user side displays the transaction screen containing the all-sell operating part, in addition to the sell-for-profit-portion operating part described above. Therefore, as the details of the routine sell order, two kinds, selling only the profit portion or selling all, can be presented to the user, and thus, the user's choice increases corresponding to the two kinds of sell orders, while ensuring the situation where the sell order can be given quickly.

In the present invention, in addition to the sell-for-profit-portion operating part described above, the communication terminal on the user side displays the specified brand trade screen containing the money-amount setting part where the setting of the money amount by the unit of money amount of which at least the first digit is 0, and the operating part which receives the sell instruction for the set money amount. Therefore, the two kinds, selling only the profit portion or selling by the unit of money amount which is set, can be presented to the user as the details of the routine sell order. Also, since the unit of money amount is configured so that the first digit is 0, the time and effort relating to the money-amount setting operation is reduced compared with the case where all digits of the money amount are numerically set. Therefore, it is applicable to the sell order of a wide range of contents and the transaction form having the function for performing a certain quick sell order can be presented to the user.

In the present invention, the communication terminal including the acquisition processor configured to acquire the average buy unit price or the latest unit price displays the transaction screen containing the acquired average buy unit price or the latest unit price. Therefore, the index for determining whether the sell instruction is given can be presented in the same screen as the screen where the sell instruction is given and it is useful for quickly performing a series of processing steps of giving the sell instruction by the user.

In the present invention, the communication terminal on the user side displays the transaction screen containing the total investment amount and the latest market value of the financial product of the one particular brand. Therefore, the index for determining whether the user gives the sell instruction for the profit portion resulted from the transaction for the financial product of the one particular brand is displayed in the same screen as the screen where the sell instruction is given, and it is useful for performing a quickly sell instruction while making the transaction screen more convenient.

Moreover, in the present invention, since the communication terminal displays the transaction screen containing the profit-and-loss of the financial product of the one particular brand, the displayed profit-and-loss can be used as the determination index whether to give the sell instruction for the profit portion.

### BRIEF DESCRIPTION OF DRAWINGS

FIG. 1 is a schematic view illustrating the entire configuration of a financial product trading system according to Embodiment 1 of the present invention.

FIG. 2 is a block diagram illustrating a primary internal configuration of a smartphone (communication terminal) which is one example of a user terminal.

FIG. 3 is a schematic view illustrating a home screen.

FIG. 4 is a schematic view illustrating a login screen.

FIG. 5 is a schematic view illustrating a top page screen (icon screen) of a stock trading application.

FIG. 6 is a schematic view illustrating a specified brand trade screen in a buy transaction state.

FIG. 7 is a schematic view illustrating the specified brand trade screen in a sell transaction state.

FIG. 8(a) is a schematic view illustrating a buy-completed screen, and FIG. 8(b) is a schematic view illustrating a sell-completed screen.

FIG. 9 is a block diagram illustrating a primary internal configuration of a system server.

FIG. 10 is a table illustrating one example of a brand DB (database).

FIG. 11 is a table illustrating one example of a user DB.

FIG. 12 is a schematic view illustrating an outline of contents of an account DB.

FIG. 13 is a table illustrating one example of contents of a user account table.

FIG. 14 is a 1st flowchart illustrating a processing procedure of a method of trading a financial product.

FIG. 15 is a 2nd flowchart illustrating the processing procedure of the method of trading the financial product.

FIG. 16 is a 3rd flowchart illustrating the processing procedure of the method of trading the financial product.

FIG. 17 is a 4th flowchart illustrating the processing procedure of the method of trading the financial product.

FIG. 18 is a 5th flowchart illustrating the processing procedure of the method of trading the financial product.

FIG. 19 is a schematic view illustrating a specified brand trade screen of one modification.

FIG. 20(a) is a schematic view illustrating a sell-for-profit-portion confirmation screen, and FIG. 20(b) is a schematic view illustrating a sell-for-profit-portion confirmation screen of one modification.

FIG. 21 is a 6th flowchart illustrating the processing procedure of the method of trading the financial product according to an indication of the sell-for-profit-portion confirmation screen.

FIG. 22 is a schematic view of one modification illustrating contents of a confirmation screen which is a window overlapped on a specified brand trade screen.

FIG. 23(a) is a schematic view of the confirmation screen indicating that there is no profit, and FIG. 23(b) is a schematic view of a confirmation screen indicating that an exceeded money amount has been set.

FIG. 24(a) is a schematic view illustrating stored contents of a user terminal according to Embodiment 2, and FIG. 24(b) is a schematic view illustrating stored contents of a system server of Embodiment 2.

FIG. 25 is a 7th flowchart illustrating a processing procedure of a method of trading a financial product of Embodiment 2.

FIG. 26 is an 8th flowchart illustrating the processing procedure of the method of trading the financial product of Embodiment 2.

FIG. 27 is a 9th flowchart illustrating the processing procedure of the method of trading the financial product of Embodiment 2.

FIG. 28 is a 10th flowchart illustrating the processing procedure of the method of trading the financial product of Embodiment 2.

FIG. 29 is an 11th flowchart illustrating the processing procedure of the method of trading the financial product of Embodiment 2.

FIG. 30 is a 12th flowchart illustrating a processing procedure of a method of trading a financial product of Embodiment 3.

FIG. 31 is a 13th flowchart illustrating the processing procedure of the method of trading the financial product of Embodiment 3.

FIG. 32 is a 14th flowchart illustrating the processing procedure of the method of trading the financial product of Embodiment 3.

FIG. 33 is a 15th flowchart illustrating the processing procedure of the method of trading the financial product of Embodiment 3.

FIGS. 34(a) and (b) illustrate transaction screens of Embodiment 4, where FIG. 34(a) is a schematic view in the buy transaction state and FIG. 34(b) is a schematic view in the sell transaction state.

FIG. 35(a) is a schematic view illustrating a state where a brand selection field of the transaction screen is developed, and FIG. 35(b) is a schematic view illustrating a state where a money-amount setting field is developed.

### MODES FOR CARRYING OUT THE INVENTION

### Embodiment 1

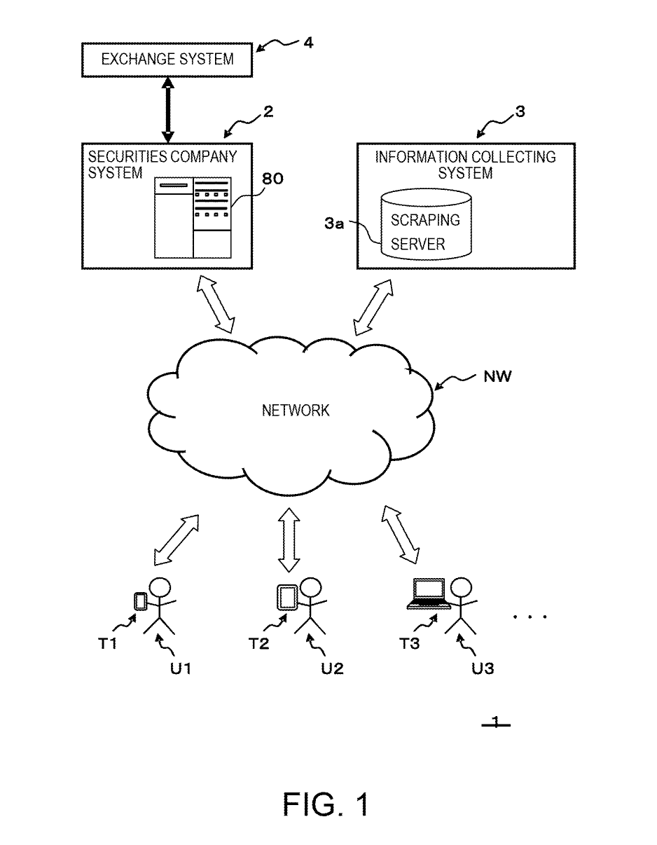

FIG. 1 illustrates a configuration of the entire outline of a financial product trading system 1 according to Embodiment 1 of the present invention. The financial product trading system 1 is to provide a stock trading service by online to users (U1, U2, U3, etc.) who are investors. The trading system 1 presents a transaction screen which is receivable of a user operation corresponding to a trade of a financial product (in this embodiment, stocks) to user terminals (T1, T2, T3, etc.), and transmits a transaction instruction of the financial product associated with a trading operation in the transaction screen to a securities company system 2 of a securities company. Especially, the present invention has a feature to present user interfaces (transaction screens) on the user terminal (T1, T2, T3, etc.) which are devised so that the user can quickly give a stock sell instruction.

In the financial product trading system 1 of this embodiment, the securities company system 2 by the securities company which provides the user interfaces described above receives trading instructions from the user terminals (T1, T2, T3, etc.), and performs transactions according to the instructions on a negotiation basis (a buy or sell transaction in which a trading method, a trading price, and a trading volume are determined between parties without an intervention of the market). Note that the securities company system 2 is comprised of a server.

The users (U1, U2, U3, etc.) have registered with the service of the online stock trade of the securities company in order to use the online stock trading, and have been given user IDs, respectively. The user terminals T1, T2, T3, etc. which the user uses correspond to communication terminals, and specifically, kind of computer-like devices having a communicating function, such as personal computers (desktop or portable personal computers) having a communicating function, and portable user terminals (tablets, smartphones, PDAs with a communicating function, cellular phones, etc.), are applicable as the user terminals.

The financial product trading system 1 of this embodiment also includes an information collecting system 3 and an exchange system 4. The information collecting system 3 includes a scraping server 3a, and provides information for the investors about corporations, etc. of brands of stocks to be traded by processing of the scraping server, etc. in response to a request from the users (U1, U2, U3, etc.). Moreover, the exchange system 4 performs a stock market transaction, and provides varieties of information according to the transaction of each brand (a stock unit price, a change in the unit price, etc. of each brand) to the securities company system 2 etc. Hereinafter, the present invention is described in detail.

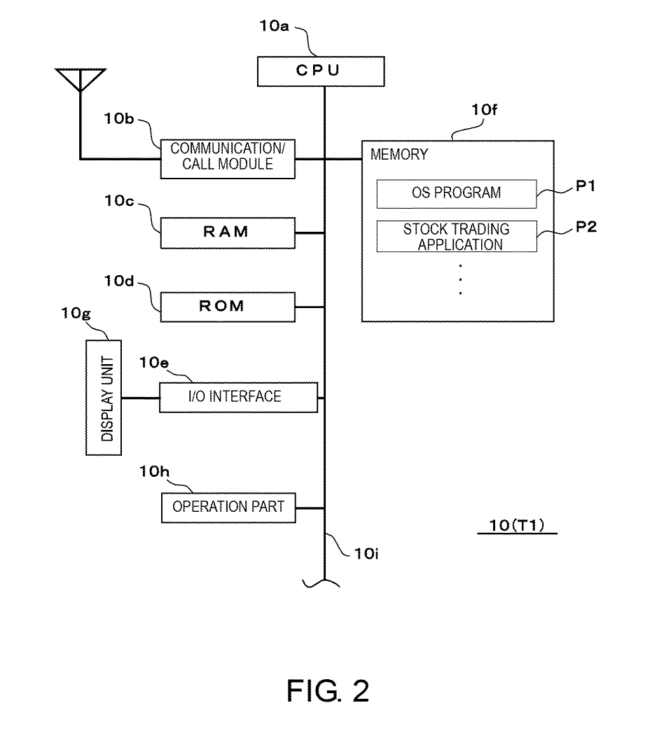

FIG. 2 illustrates a primary internal configuration of a smartphone 10 (communication terminal) which is one example of the user terminal (T1, T2, T3, etc.). The smartphone 10 corresponds to a kind of computer (a computer including a communicating device and a memory device) which performs various processing steps according to program(s). The smartphone 10 has a CPU 10a (a processor 10a) that performs overall controls and various processing with various devices, such as a communication/call module 10b (corresponding to the communicating device), a RAM 10c, a ROM 10d, an I/O interface 10e, and a memory 10f (corresponding to the memory device), that are connected via an internal connection line 10i. An operation part 10h which is operable by the user is also connected with the internal connection line 10i.

The communication/call module 10b of the smartphone 10 has, in addition to wireless communications processing through a network, a function to make a phone call to a given telephone number according to a control of the CPU 10a (a call function) and a function to receive a phone call (an in-call function). The RAM 10c temporarily stores contents, files, etc. associated with the processing of the CPU 10a. The ROM 10d stores program(s) which define basic processing details of the CPU 10a, and also stores a unique ID (UID) which identifies the smartphones 10. Note that when the communication/call module 10b communicates (transmits), the UID is included in transmitting contents (e.g., the transmission is performed with the UID included in a header of a transmitting packet).

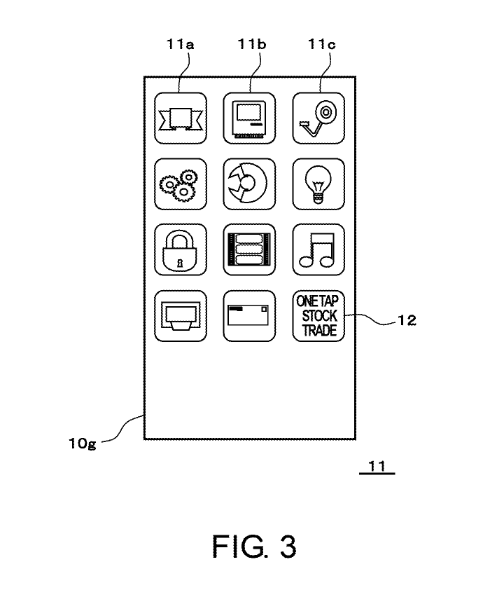

The I/O interface 10i is connected with a display unit 10g having a touch-panel function. The I/O interface outputs various screens generated by a control of the CPU 10a (see screens illustrated in FIGS. 3 to 8, etc.) to the display unit 10g, and thus, the outputted screen contents are displayed on the display unit 10g. The I/O interface 10i also sends operational contents which are received in response to the user touching the surface of the display unit 10g, to the CPU 10a.

Note that the operational contents received in response to the user touching the surface of the display unit 10g vary suitably according to the screen contents currently displayed, and for example, in a case where a home screen 11 (see FIG. 3) which is a basic screen of the smartphone 10 is displayed on the display unit 10g, when the surface corresponding to an arranged location of any one of various icons 11a, 11b, 11c, etc. which are contained in the home screen 11 is touched by the user, the I/O interface 10g receives a selecting operation of the icon located at the touched location (e.g., the icon 11a), and sends information on the received selecting operation of the icon to the CPU 10a.

The operation part 10h is comprised of hardware buttons provided to a casing of the smartphone 10, and when the operation part 10h is operated, the CPU 10g is notified that the operation part 10h is operated. The implications by the operation of the operation part 10h may vary according to the processing situation of the smartphone 10. For example, in a situation where an application is activated, when the operation part 10h is operated, since an operation which terminates the application is performed, the operation of the operation part 10h is to receive a terminating instruction of the application from the user in this case. In the present invention, since a stock trading application P2 for the online stock trading service (installed in the memory 10f) is used, as will be described later, in a state where the stock trading application P2 is activated, when the operation part 10h is operated, it means that the smartphone 10 has received a terminating instruction of the stock trading application P2, and thus, a logoff instruction of the stock trading application P2 is transmitted to the securities company system 2.

The memory 10g stores (installed) programs, such as an OS program P1, the stock trading application P2, and other various applications. The OS program P1 is a basic program corresponding to an operating system, and defines processing of the CPU 10a which causes the smartphone 10 to function as a kind of computer. One of the basic types of processing defined by the OS program P1 is to first display the home screen 11 (see FIG. 3) on the display unit 10g when the smartphone 10 becomes in an available state. In the home screen 11, the arrangement of the icons 11a, 11b, 11c, etc. according to the various applications installed in the memory 10g is also the processing defined by the OS program P1.

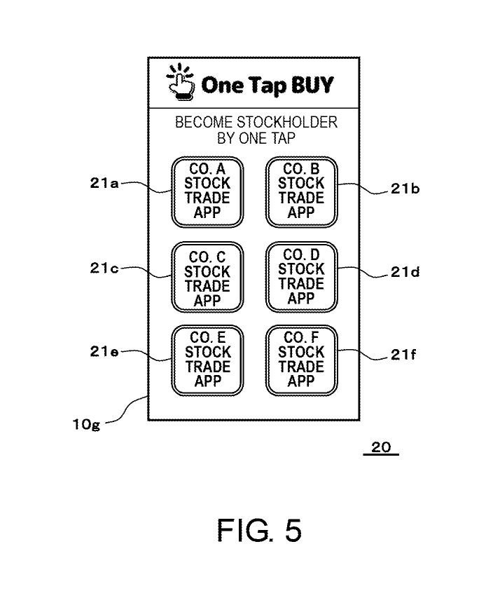

The stock trading application P2 stored in the memory 10g is an application program (computer program) for the online stock trading service provided by the securities company system 2. The stock trading application P2 defines that the CPU 10a displays various screens for trading stocks (see FIGS. 5 to 8, etc.) on the user terminal, and performs various control according to processing for transmitting a transaction instruction, etc. to the securities company system 2 in response to the user operation in the screen. Thus, the CPU 10a functions as a generating processor of the transaction screen, etc. by such a definition. Note that the stock trading application P2 includes, in addition to program codes which define the processing, screen data corresponding to various screens.

As illustrated in FIG. 3, when the stock trading application P2 is installed in the memory 10g, a stock-trade icon 12 for starting the stock trading application P2 is then arranged so as to be selectable in the home screen 11 based on the OS program P1.

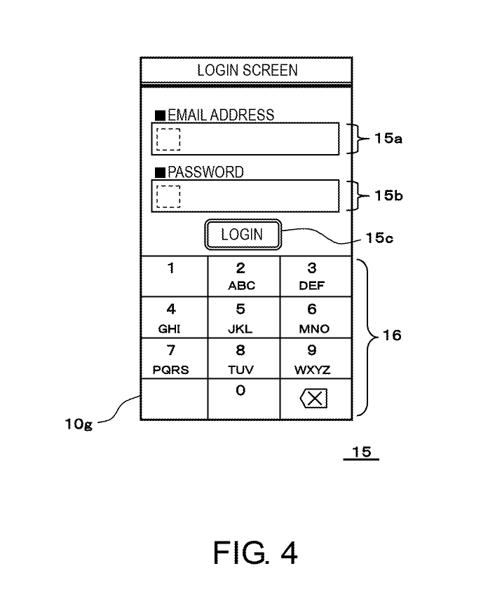

FIG. 4 illustrates a login screen 15 displayed on the display unit 10g when the operation by the user selecting the stock-trade icon 12 on the home screen 11 is received. The stock trading application P2 defines that, upon the selection of the stock-trade icon 12, the CPU 10a displays the login screen 15 when the user has not logged in the stock trading service.

The login screen 15 is generated based on the screen data for the login screen, where an email address input field 15a, a password input field 15b, and a selectable login button 15c are arranged. The screen data for the login screen also contains the parts data corresponding to the respective parts arranged as described above. In the state where the login screen 15 is displayed, by the function corresponding to the processing defined by the OS program P1 described above, a software keyboard 16 is displayed on the display unit 10g, and the user operates each key included in the software keyboard 16 to input given contents into the input fields 15a and 15b. Note that an email address and a password to enter are determined for each user at the time of the user registration to the stock trading service.

Then, in a state where the given contents are inputted into the input fields 15a and 15b, when the smartphone 10 receives a user selecting operation of the login button 15c, the inputted contents are configured to be transmitted to the securities company system 2. The data which defines the contents, etc. configured in such a fashion (data described in script-type languages, etc.) is also contained in the screen data for the current login screen (the contents related to such a selection button are the same in other screen data).

FIG. 5 illustrates a top page screen 20 (corresponding to an icon screen) of the stock trading application P2, and when the smartphone 10 receives a notice of the completion of the current login processing on the login screen 15, the top page screen 20 is displayed on the display unit 10g. In the top page screen 20, stock-trade icons 21a-21f of Companies A to F for starting transactions of brands corresponding to Companies A to F are arranged in the same screen. Note that the notice associated with the completion of login which is transmitted from the securities company system 2 accompanies varieties of information, such as information on the stock price of the given brand at the moment of login and past trading information of the user who performed the current login processing, and the variety of information received with the notice is then temporarily stored in the RAM 10c.

In this embodiment, in order to free the user from the brand selection work, the securities company side which provides the stock trading service has extracted beforehand brands of six companies (Companies A to F) as candidates for trading, and the user then selects a candidate for trading from the extracted brands. As such candidates for trading, in order to increase the possibility that those candidates become trading targets for a wider variety of people, it may be suitable to select brands of prominent companies. For example, such candidates for trading may be selected from companies in Japan, or may be selected from the prominent companies in a certain overseas country, and a trading service for the corresponding country may be provided (e.g., brands may be selected from very prominent companies listed in the U.S. Market). Note that the number of companies (the number of brands) selected by the securities company side is not limited to six companies, and the number may be suitably varied from six. However, it is desirable to arrange the icons of at least five or more brands so that it does not fall into “a recommendation of one particular brand of stocks” in the association's voluntary regulatory rules of the stock trade industry.

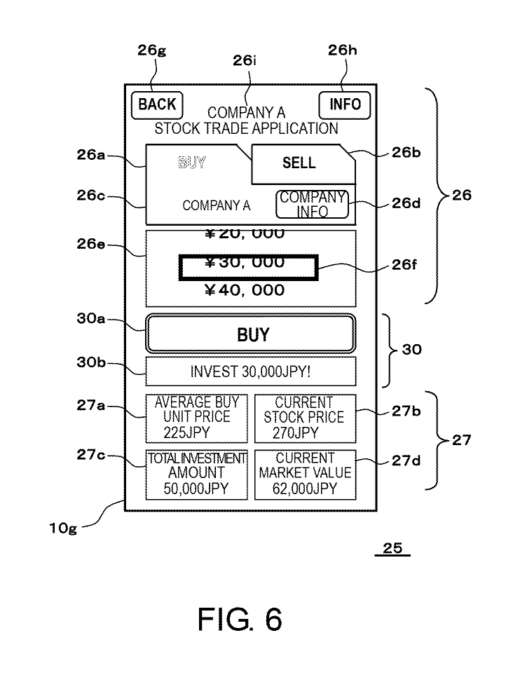

FIG. 6 illustrates a buy transaction state of a specified brand trade screen 25 corresponding to Company A (corresponding to one particular brand of stocks). The buy transaction state is displayed on the display unit 10g by the control of the CPU 10a based on the definition of the stock trading application P2 in response to a reception of a selection of the stock-trade icon 21a of Company A among the plurality of trade icons 21a-21f contained in the top page screen 20 of FIG. 5. The specified brand trade screen 25 illustrated in FIG. 6 is a transaction screen dedicated to a stock trade of Company A. A fundamental configuration of the specified brand trade screen 25 is equivalent to transaction screens dedicated to stocks of Companies B to F which are displayed when the stock-trade icons 21b-21f of Companies B to F other than the stock-trade icon 21a of Company A are selected, respectively, and a text part where the company name is indicated (a screen title 26i etc.) differs. Note that the specified brand trade screen of this embodiment is configured for a stock trade by a unit of money amount.

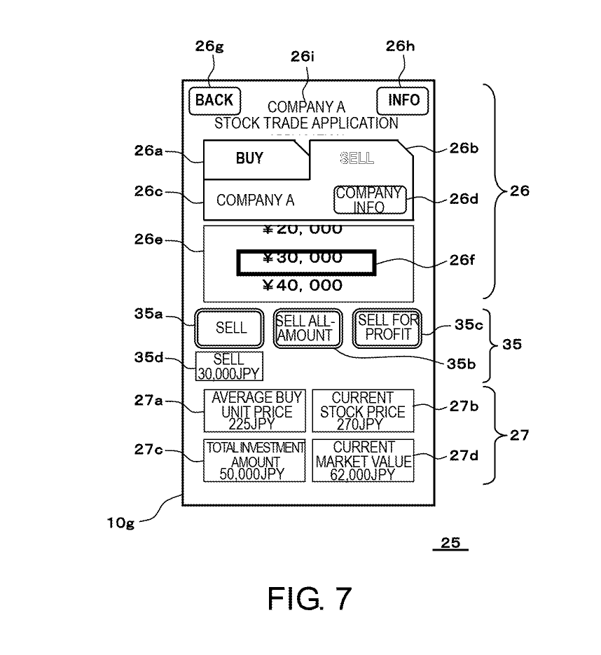

In the specified brand trade screen 25 of FIG. 6, an upper screen portion is a first common part 26, a portion near a lower part from the center of the screen is a buying part 30 dedicated to the buy transaction state, and a lower screen portion is a second common part 27. As illustrated in FIGS. 6 and 7, the specified brand trade screen 25 is configured to switch between the buy transaction state illustrated in FIG. 6 and the sell transaction state for selling illustrated in FIG. 7. The first common part 26 and the second common part 27 are parts both maintain in the same configuration without being changed even if the screen state changes. On the other hand, the portion near the lower part from the center of the screen changes in the configuration in response to the switching of the screen state.

In the first common part 26, a back button 26g is arranged at an upper left corner of the screen, and an information button 26h is arranged in an upper right corner of the screen. The back button 26g is a selectable button for returning to the top page screen 20 of FIG. 5, and it is selected when changing to trading of other brands. The information button 26h is a selectable button for displaying information relevant to the trading, and when it is selected, the specified brand trade screen 25 is switched to a menu screen (not illustrated) where an item to be displayed is selected. The items to be displayed include a precontract document and a risk disclosure, and if the trading brand belongs to a foreign company, contents of foreign securities, etc. may be included. In addition, a user's trade history may be included in the items of the menu screen, and when one item of the trade history is selected, a request of the user history related to the currently-displayed particular brand of stocks of the specified brand trade screen 25 is transmitted to the securities company system 2, and a trade history received corresponding to the transmission of the request is displayed.

In addition, between the back button 26g and the information button 26h, “Stock Application for Company A” which is the screen title 26i for Company A is arranged. Note that if the specified brand trade screen 25 is for Company B (if the trade icon 21b of Company B is selected in the top page screen 20 of FIG. 5), the screen title 26i indicates “Stock Application for Company B,” and if it is for Company C (if the trade icon 21c of Company C is selected in the top page screen 20) indicates “Stock Application for Company C” (similar for other Companies D to F).

In addition, in the specified brand trade screen 25, a buy button 26a and a sell button 26b which are receivable of a selecting operation are arranged below the screen title 26i of the first common part 26. One of the buttons 26a and 26b is in a selectable state (active state), and when the selectable one is operated, the buy transaction state and the sell transaction state are suitably switched therebetween. That is, in the buy transaction state, only the sell button 26b is selectable (active state), and on the other hand, in the sell transaction state, only the buy button 26a is selectable. The buy/sell transaction state is switched by performing the selecting operation of the active button 26a or 26b.

Note that the sell button 26b may not be selectable in the specified brand trade screen 25 in the buy transaction state. Thus, the CPU 10a detects whether information that the logged-in user possesses stocks of Company A is included in information sent associated with the notice of the completion of login (information temporarily stored in the RAM 10c), and if the information on that the user possess the stocks of Company A cannot be detected, the CPU 10a changes the state into a state where the sell button 26b is not selectable and the specified brand trade screen 25 in the buy transaction state is displayed. In this case, the logged-in user can only perform a buy transaction for the stocks of Company A. Note that the specified brand trade screen 25 is in the buy transaction state illustrated in FIG. 6 immediately after being displayed on the display unit 10g.

In addition, in the specified brand trade screen 25, a brand field 26c is arranged below the buy/sell buttons 26a and 26b in the first common part 26. In the brand field 26c, if the specified brand trade screen 25 of FIG. 6 is for Company A, the company name of Company A is arranged, and for Company B, the company name of Company B is arranged (similar for other Companies C to F). In the brand field 26c, a selectable brand button 26d (a corporate information button) is then arranged, and if the brand button 26d receives a selecting operation of the user, it accesses the information collecting system 3 illustrated in FIG. 1 to transmit an acquisition request of information on Company A. Then, when the smartphone 10 receives the information on Company A (IR information, etc.) from the scraping server 3a of the information collecting system 3 in response to the transmission of the acquisition request, the received information is displayed on the display unit 10g. This is also defined by the stock trading application P2. Note that such received information may be displayed in the form of another window or a pop-up so as to overlap with the specified brand trade screen 25, or a screen switched from the specified brand trade screen 25.

In addition, in the specified brand trade screen 25, a money-amount setting field 26e is arranged below the brand field 26c. The money-amount setting field 26e is to set a money amount for the buy transaction. In this embodiment, the money-amount setting field 26e is configured to set the money amount with last four digits being all zero in Japanese Yen or JPY (a unit of 10,000 JPY). When the surface of the display unit 10g corresponding to the money-amount setting field 26e is touched, the money-amount indication of the unit of 10,000 JPY is configured to rotate like a slot machine (it is called a “Picker” if used in the smartphone, etc.), and the money-amount indicated in a money-amount frame 26f provided in the money-amount setting field 26e is used as a set money amount setting. Therefore, since the user can perform an operation for touching the surface of the display unit 10g so that the money-amount setting field 26e is rotated like the slot machine (an operation to slide the display surface with a finger upwardly or downwardly) to easily set the money-amount (specified by the money amount), and especially, the money amount is configured to be the unit of 10,000 JPY, the user can quickly set the money amount from a wide range of money amount even if the rotation is a little.

In addition, in the specified brand trade screen 25, the buying part 30 is arranged below the first common part 26 described above, and the buying part 30 includes a buy button 30a and a money-amount-setting indicating field 30b. The buy button 30a is a button (corresponding to a buy operation part) which receives a user operation of a buying instruction (a buy order) of stocks of Company A. When the user operation is received by the buy button 30a, the CPU 10a transmits a buy instruction (a buy order) of the stocks of Company A by the money amount which is set in the money-amount setting field 26e, to the securities company system 2. Note that the buying instruction to be transmitted includes brand information indicative of one brand for trading (a brand ID), and money-amount information indicative of the money amount setting.

A money-amount confirmation field 31b automatically displays the money amount which synchronizes with the amount indicated in the money-amount frame 26f of the money-amount setting field 26e described above, by the control of the CPU 10a. By checking the text indicated in the money-amount confirmation field 31b (e.g., “Invest 30,000 JPY!”), the user can certainly confirm the buying money amount.

In addition, in the specified brand trade screen 25, the second common part 27 is arranged below the buying part 30 described above, and the second common part 27 includes an average buy unit price field 27a, a current stock price field 27b, a total investment amount field 27c, and a current market value field 27d.

The average buy unit price field 27a indicates a user's average buy unit price of stocks of Company A at the moment of login, and the price is extracted from the information transmitted to the smartphone 10 from the securities company system 2 in response to the completion of login by the login operation in the login screen 15 described above. That is, from the variety of information temporarily stored in the RAM 10c, the average buy unit price of the stocks of Company A is extracted by the CPU 10a in response to the selection of the stock-trade icon 21a of Company A, and is then arranged in the average buy unit price field 27a.

The current stock price field 27b is a field indicating the latest stock price (the newest stock price) of the stocks of Company A at the moment of login. The price is extracted by the CPU 10a from the variety of information stored in the RAM 10c, similar to the average buy unit price of the stocks of Company A described above, and is then arranged in the current stock price field 27b.

The total investment amount field 27c is a field indicating the total amount of money invested to the stocks of Company A by the logged-in user before the current login (the total amount of money paid in purchasing the stocks of Company A so far). The total amount is also extracted by the CPU 10a from the variety of information stored in the RAM 10c, similar to the average buy unit price of the stocks of Company A described above, and is then arranged in the total investment amount field 27c. The current market value field 27d is a field indicating a market value of the stocks of Company A which have been purchased by the logged-in user before the current login (the newest market value for all the stocks Company A purchased so far which is calculated based on the stock price at the moment of login). This market value is also extracted by the CPU 10a from the variety of information stored in the RAM 10c, and is then arranged in the current market value field 27d, similar to the average buy unit price of the stocks of Company A described above.

Thus, since the second common part 27 indicates the various numerical values in the fields 27a-27d, the user can take advantage of the indicated contents as indexes to determine whether he/she should place a buy order. In addition, since the information is indicated in the same screen as the operation screen where the buy order is performed, switching between the screens etc. becomes unnecessary when determining the propriety of a buy order and it can contribute to performing a quick buy order.

FIG. 7 illustrates the specified brand trade screen 25 in the sell transaction state, and the state illustrated in FIG. 7 has been switched from the screen state illustrated in FIG. 6 in response to the sell button 26b of the first common part 26 receiving a selecting operation of the user in the buy transaction state illustrated in FIG. 6. In the specified brand trade screen 25 in the sell transaction state of FIG. 7, although the first common part 26 and the second common part 27 are fundamentally equivalent to those in FIG. 6, it differs from FIG. 6 in that the buy button 26a is selectable.

In addition, a selling part 35 arranged between the first common part 26 and the second common part 27 is configured only for selling. In FIG. 7, from left to right, a money-amount-specified sell button 35a (corresponding to a sell-for-money-amount operating part), an all-amount sell button 35b (corresponding to a sell-all operating part), and a profit-portion sell button 35c (corresponding to a sell-for-profit-portion operating part) are arranged so as to be receivable of a selecting operation of the user. In addition, a money-amount confirmation field 35d is arranged below the money-amount-specified sell button 35a.

The money-amount-specified sell button 35a is to transmit a sell instruction for the money amount set in the money-amount setting field 26e of the first common part 26 (a sell instruction of the stocks of Company A in FIG. 7) to the securities company system 2, similar to the case of the buy button 30a illustrated in FIG. 6 as described above. The money-amount confirmation field 35d is similar to the money-amount confirmation field 30b illustrated in FIG. 6 described above, and automatically displays a money-amount indication synchronized with the money amount setting in the money-amount setting field 31a of the first common part 26 by the control of the CPU 10a. Thus, the user is able to certainly give a sell instruction at the desired amount of money after the user confirmed the amount of money set by himself/herself. Note that the money-amount-specified sell instruction transmitted to the securities company system 2 includes brand information (a brand ID) indicative of one particular brand of stocks for trading (e.g., Company A) and money-amount information indicative of the set money amount, etc.

The all-amount sell button 35b is to give a sell instruction for all the stocks of a particular brand possessed by the logged-in user. When a user operation is received by the all-amount sell button 35b, the CPU 10a transmits the sell instruction for all the stocks possessed by the logged-in user (all the stocks of Company A in FIG. 7) to the securities company system 2. Note that the all-amount sell instruction also includes the brand information (the brand ID) indicative of one particular brand of stocks for trading and instruction information indicative of selling all the amount.

The profit-portion sell button 35c is to give a sell instruction for a profit portion resulted from the possessed stocks (one particular brand of stocks corresponding to the currently-displayed specified brand trade screen 25). When a user operation is received by the profit-portion sell button 35c, the CPU 10a transmits the sell instruction for the profit portion resulted from the possessed stocks (the stocks of Company A in FIG. 7, and corresponding to the financial product of one particular brand) of the logged-in user, to the securities company system 2. Note that the sell instruction for the profit portion includes the brand information (the brand ID) indicative of one particular brand of stocks for trading and instruction information indicative of selling the profit portion, etc.

Also in the specified brand trade screen 25 in the sell transaction state illustrated in FIG. 7, since the various numerical values are indicated in the fields 27a-27d of the second common part 27 described above, the indicated contents are usable for indexes to determine whether the sell instruction should be given, or which pattern of the sell instruction is used among the three patterns described above when the sell instruction is decided to be given. In addition, since these indexes are indicated in the same screen as the operation screen of the buying instruction, the switching between the screens etc. becomes unnecessary when making various determinations according to the sell instruction, and the sell instruction can be performed quickly by one-touch operation of one of the three patterns.

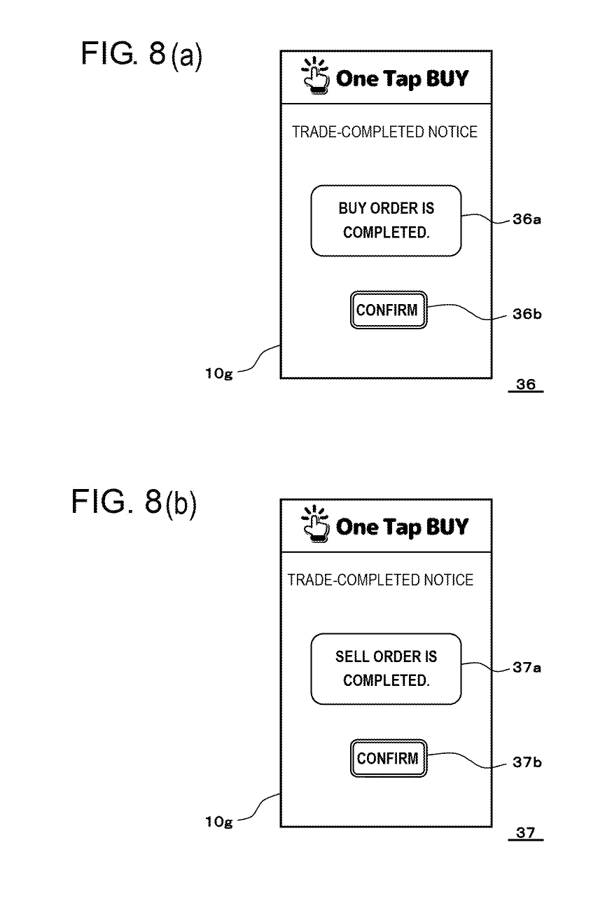

FIG. 8(a) illustrates a buy-completed screen 36, and is displayed on the display unit 10g when the user operates the buy button 30a in the specified brand trade screen 25 in the buy transaction state of FIG. 6 and the processing for the buy order is completed. The stock trading application P2 defines that, when the processing for the buy order is completed, since a buy-completed notice is transmitted from the securities company system 2 as will be described later, the CPU 10a displays the buy-completed screen 36 on the display unit 10g by using the reception of the buy-completed notice as a trigger. In addition, the buy-completed screen 36 includes a text 36a indicative of the processing for the buy order being completed, and a confirmation button 36b. The stock trading application P2 also defines that, when the confirmation button 36b receives a selecting operation of the user, the CPU 10a controls to switch the screen to the indication of the top page screen 20 illustrated in FIG. 5 in order to allow the user to trade other brands.

FIG. 8(b) illustrates a sell-completed screen 37, and is displayed on the display unit 10g when any one of the money-amount-specified sell button 35a, the all-amount sell button 35b, and the profit-portion sell button 35c is operated by the user in the specified brand trade screen 25 in the sell transaction state of FIG. 7, and the sell transaction for the sell instruction is completed. The stock trading application P2 defines that, when the sell transaction is completed, since a sell-completed notice is transmitted similar to the case of the buy transaction described above, the CPU 10a displays the sell-completed screen 37 on the display unit 10g by using the reception of the sell-completed notice as a trigger. In addition, the sell-completed screen 37 also includes a text 37a indicative of the processing for the sell order being completed, and a confirmation button 37b. The stock trading application P2 also defines that, when the confirmation button 37b receives a selecting operation, the CPU 10a controls to switch the screen to the indication of the top page screen 20.

Therefore, the stock trading application P2 of this embodiment defines the processing for displaying the various screens (FIGS. 5 to 8, etc.) described above to allow the user to give a buy/sell instruction quickly with one-touch operation. When the user selects a particular brand of stocks (icon) which he/she wants to trade on the top page screen of FIG. 5, the buy/sell instruction can then be given in the specified brand trade screen 25 illustrated in FIGS. 6 and 7. Since an input operation of the money-amount by a keyboard, etc. is eliminated in the buy/sell instruction, the instruction can quickly be given, and since the contents of the three routine patterns of the sell instruction are presented, the contents meet investment styles of typical users.

Although the description of the smartphone 10 is as above, personal computers, tablets, PDAs with a communicating function, cellular phones, etc. are applicable to the user terminals T1, T2, T3, etc. other than the smartphones as described above. Among the devices other than the smartphones, the devices without the touch-panel function differ from the configuration illustrated in FIG. 2 in that a display unit is connected with an output interface from which display information is outputted, and in that key button switches which receive operations of the user is connected with an input interface. Other than that, the devices are fundamentally equivalent to the configuration illustrated in FIG. 2. For this reason, the configuration of the user terminals T1, T2, T3, etc. which are applicable to the present invention corresponds to the configuration illustrated in FIG. 2 for primary parts. Next, the securities company system 2 which provides the online stock service of this embodiment is described.

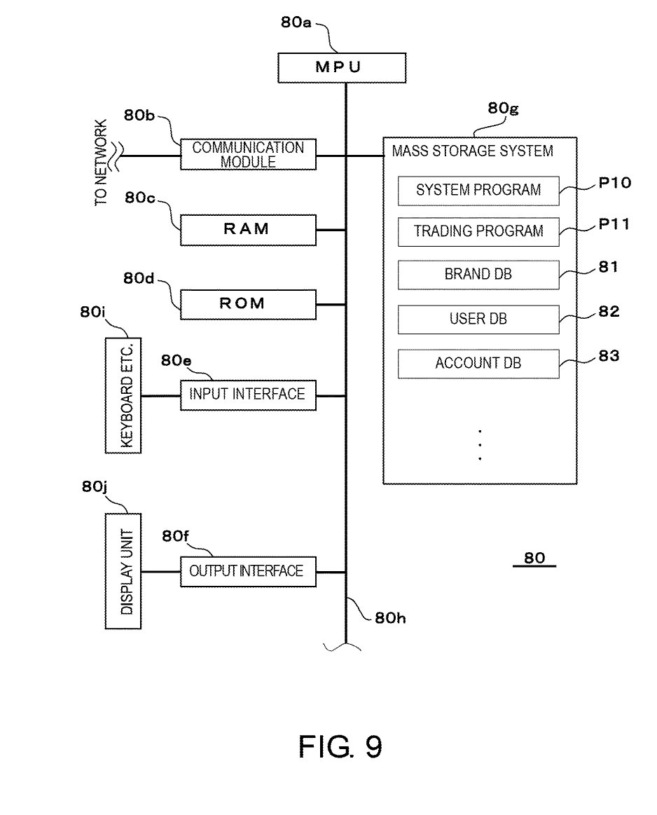

FIG. 9 illustrates a system server 80 (corresponding to a server) included in the securities company system 2. The system server 80 constitutes a backbone part of the securities company system 2, and performs necessary processing for providing the online stock service to the users. Note that, although in FIG. 9 the system server 80 is illustrated as a server computer, for example, the system server 80 may be configured by combining a plurality of server computers, database systems, etc. which perform distributed processing etc. for various processing to be performed by the system server 80. The configuration with such a plurality of machines also corresponds to the server of the present invention. Hereinafter, the system server 80 is described.

A typical server computer is applied to the system server 80 in this embodiment, where a MPU 80a (a controller 80a) which performs overall control and various processing is connected with various devices, etc. via an internal connection line 80h. The various devices include a communication module 80b, a RAM 80c, a ROM 80d, an input interface 80e, an output interface 80f, and a mass storage system (a HDD system) 80g.

The communication module 80b is a communication device (a communicating device) corresponding to a connection module with the network, and complies with necessary telecommunications standards (e.g., a LAN module). The communication module 80b is connected with the network (an internal or external network of the securities company system 2) through a necessary communication device (illustration is omitted, and for example, corresponding to a router, etc.). The communication module 80b enables communications with the user terminals T1, T2, T3, etc., and various external servers (the scraping server 3a, a web server, a database server, etc.).

The RAM 80c temporarily stores contents, files, etc. associated with processing of the MPU 80a, and the ROM 80d stores program(s), etc. which define basic processing contents of the MPU 80a. The input interface 80e is connected with a keyboard 80i, a mouse, etc. which receive operational instructions from a system administrator, etc. of the securities company, and transmits the operational instructions, etc. received from the system administrator, etc. to the MPU 80a. The output interface 80f is connected with a display unit 80j (a display output device), and outputs the contents associated with the processing of the MPU 80a to the display unit 80j so that the system administrator, etc. is able to check the current contents of processing etc.

The mass storage system 80g (corresponding to a storage-medium device) stores program(s), databases (DBs), etc., and in this embodiment, stores a system program P10, a trading program 11, a brand DB 81, a user DB 82, and an account DB 83, etc.

The system program P10 defines various types of processing according to the operation system for the server, the system server 80 fundamentally functions as the server by the MPU 80a executing processing based on these definitions. The trading program P11 will be described later, but the brand DB 81, etc. are described first.

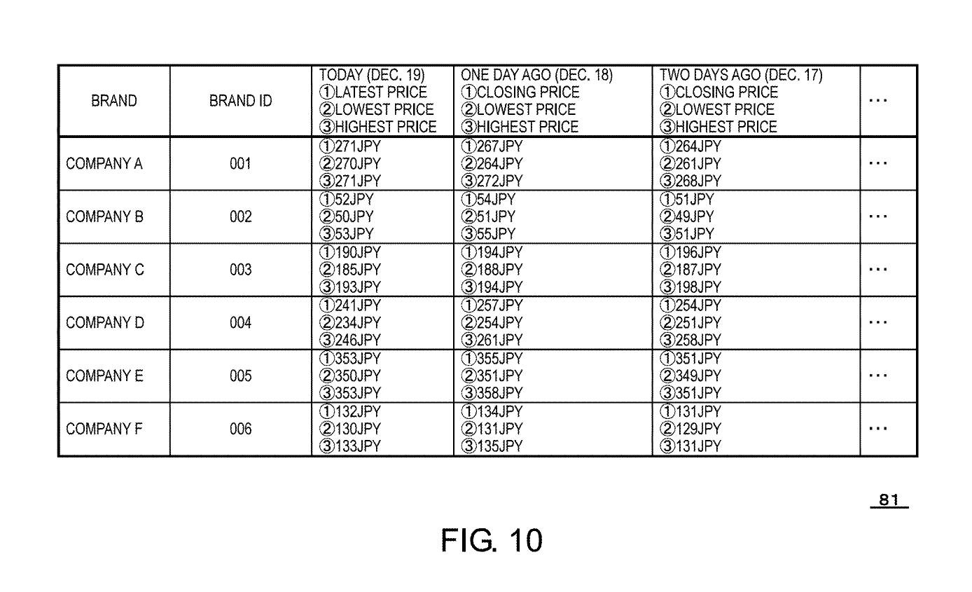

FIG. 10 illustrates one example of contents of the brand DB 81. In this embodiment, since the securities company system 2 narrows the brands dealt by the bilateral transaction to the six Companies A-F as described above, the brand DB 81 stores closing prices, top prices, and lowest prices of each day so as to be associated with the brand ID which is assigned to each of Companies A-F. Note that if the closing prices have not become settled on the latest day, latest prices at that time are stored instead of the closing prices. Each price stored in the brand DB 81 indicates a price by the bilateral transaction. Alternatively, it may be a price referring to variety of information transmitted from the exchange system 4 illustrated in FIG. 1, and the contents of the brand DB 81 may be updated whenever necessary according to trading conditions.

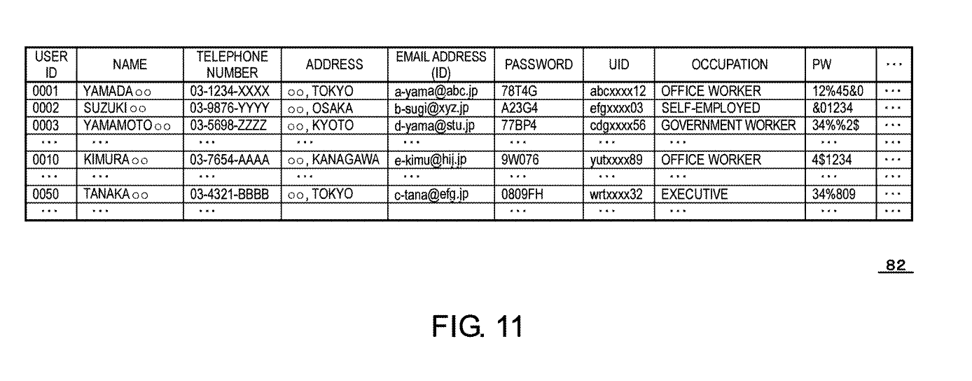

FIG. 11 illustrates an outline of contents of the user DB 82. The user DB 82 is a database which stores variety of information of the users who registered with the online stock trading service provided by the securities company system 2 and opened their accounts for trading. Upon the user registration, user IDs which identify the users are assigned to the registered users by the securities company system 2, and the user DB 82 stores the variety of information so as to be associated with the assigned user IDs. Specifically, the user DB 82 stores a user's name, an address, a telephone number, an email address, a UID (the unique ID of the user terminal), an occupation, a password, etc. for every user ID. Note that in this embodiment, the registered email address is used as the login ID at the moment of login, and the password uses alphanumeric character information registered by the user when the user registered. Note that the contents of the user DB 82 are suitably updated by the service management side according to the registration of a new user or a withdrawal of the registered user.

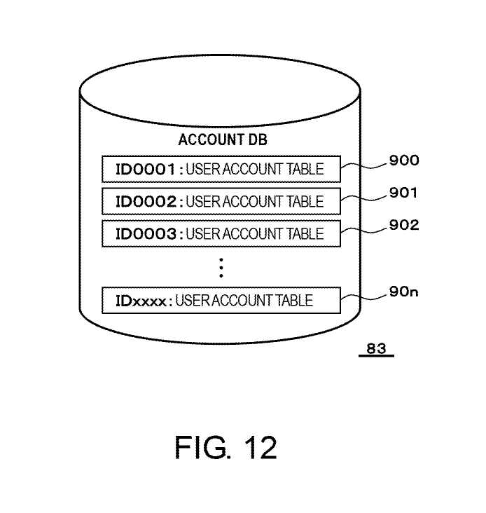

FIG. 12 illustrates the outline of contents of the account database 83 stored in the mass storage system 80g described above. The account database 83 corresponds to a trade history database which stores histories of sales transactions by the registered users. The account database 83 is configured, for every user ID, to have user account tables 900, 901, 902, etc. which store the account information related to stock trade histories of the users (date information on which stocks were traded, information on the number of traded stocks, information on the money amount used for trades, etc.), and thus it is able to store the account information on every user (the user ID).

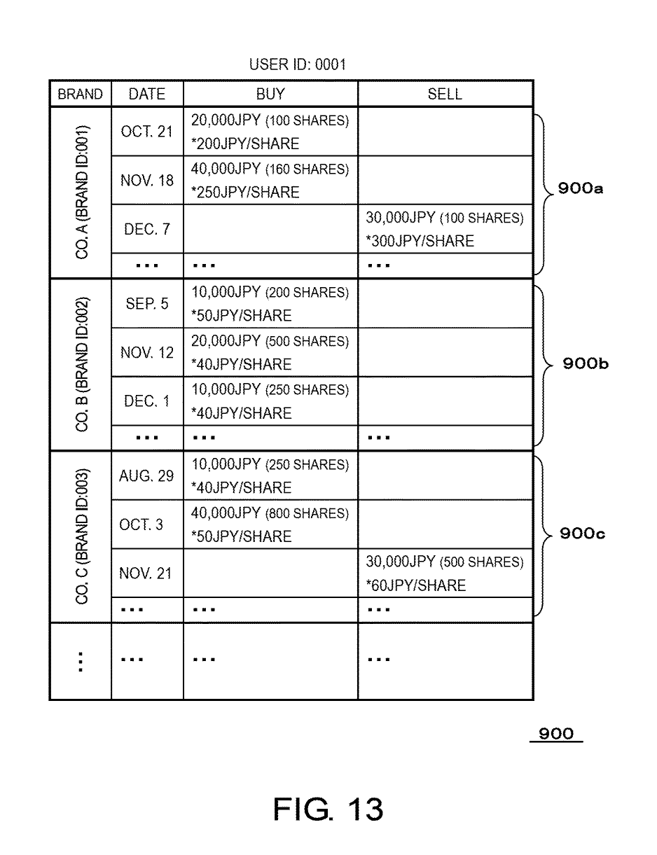

FIG. 13 illustrates one example of contents of the user account table 900 for the user ID of 0001. The user account table 900 stores data related to stock trades of each brand, and stores date and contents of the sales transactions (a purchased price, the number of purchased stocks, a sold price, the number of sold stocks, a trading stock unit price, etc.) in trading fields 900a, 900b, 900c, etc. corresponding to each brand (a brand ID). The information indicative of contents of transactions is stored in such a user account table 900 associated with transactions according to trading instructions of the user whenever necessary by the control of the MPU 80a.

Next, details of the processing defined by the trading program P11 stored in the mass storage system 80g of the system server 80 of the securities company system 2 are described. The trading program P11 of this embodiment defines types of control processing, etc., which are executed by the MPU 80a for the logins, sales transactions, etc. by the users. First, as for the user's login, the trading program P11 defines that, when the communication module 80b receives the login information (the user's email address, password, UID, of the user terminal, etc.) transmitted from the user terminal, the MPU 80a determines whether the received login information matches with the information stored in the user DB 82 of FIG. 11.

The trading program P11 defines that, if the MPU 80a determines that the received login information is not stored in the user DB 82, it then performs a control to transmit the result of non-matching of the login information to the user terminal which is a sender of the login information, by using the communication module 80b. On the other hand, if it is determined that the received login information is stored in the user DB 82, the user ID corresponding to the login information is set as the currently logged-in state, and the login state information indicative of the user being currently logged-in is stored in the RAM 80c, etc. This login state information will be stored until logoff information is received.

The trading program P11 defines that, when a buy instruction is received from the user terminal which became into logged-in state, the MPU 80a identifies the latest price at the moment of a reception of the buy instruction based on the brand DB 81 of FIG. 10 as a stock price of a brand which is indicated by the brand information contained in the buy instruction, and calculates the number of stocks to be purchased (the number of stocks to be traded) by dividing the money amount indicated by the money-amount information contained in the received buy instruction by the identified latest stock price. The trading program P11 defines that the MPU 80a then performs a buy bilateral transaction by the number of stocks within the tradable range based on the calculated number of stocks to be purchased. Note that if the calculated number of stocks to be purchased in this case is less than the number of stocks within the tradable range, the CPU 80a performs a buy transaction by the number of stocks within the tradable range. The trading program P11 defines that, when the buy transaction is completed, the MPU 80a transmits a buy-completed notice to the user terminal which transmitted the buy instruction, by using the communication module 80b.

In addition, the trading program P11 defines that, when a sell instruction with the money amount being set is received from the user terminal which became into logged-in state, the MPU 80a identifies the latest price at the moment of a reception of the sell instruction based on the brand DB 81 of FIG. 10 as a stock price of the brand indicated by the brand information contained in the sell instruction, and calculates the number of stocks to sell (the number of stocks to be traded) by dividing the money amount indicated by the money-amount information contained in the received sell instruction by the identified latest stock price. The trading program P11 defines that the MPU 80a then performs a sell negotiated transaction by the number of stocks within the tradable range based on the calculated number of stocks to sell. Note that also in the sell transaction, if the calculated number of stocks to sell is less than the number of stocks within the tradable range similar to the case of buying described above, the CPU 80a performs the sell transaction by the number of stocks within the tradable range. The trading program P11 defines that, when the sell transaction is completed, the MPU 80a transmits a sell-completed notice to the user terminal which transmitted the sell instruction, by using the communication module 80b.

In addition, the trading program P11 defines that, when a sell-all instruction is received from the user terminal which became into logged-in state, the MPU 80a identifies the user account table corresponding to the logged-in user, among the account DB 83 illustrated in FIG. 12, and then identifies the total number of stocks possessed by the user (the number of stocks to be traded) based on the information stored in the brand field indicated by the brand information contained in the received sell-all instruction, among the identified user account table. The trading program P11 defines that the MPU 80a then performs the sell transaction by the number of stocks within the tradable range based on the identified total number of stocks. Subsequent processing steps are similar to those of the sell instruction with the money amount being set as described above, and thus a sell-completed notice will be transmitted to the user terminal which transmitted the sell instruction.

Further, the trading program P11 also defines that, when a sell instruction for a profit portion is received from the user terminal which became into logged-in state, the MPU 80a identifies the latest price (a unit price of the financial product) at the moment of a reception of the sell instruction for the profit portion among the brand DB 81 of FIG. 10, as a stock price of the brand indicated by the brand information contained in the sell instruction for the profit portion. In addition, the trading program P11 defines that the MPU 80a identifies the user account table corresponding to the logged-in user among the account DB 83 illustrated in FIG. 12, extracts the history information related to the sales transaction stored in the brand field indicated by the brand information contained in the received sell instruction for the profit portion among the identified user account table, and calculates the contracted money amount of each sales transaction based on the extracted history information and the identified latest unit price (stock price) to calculate the profit portion.

Subsequent processing steps are similar to those of the sell instruction with the money amount being set as described above, and thus, the MPU 80a divides the calculated money amount for the profit portion by the identified latest stock price to calculate the number of stocks to sell (the number of stocks to be traded), and performs a sell transaction of the number of stocks within the tradable range based on the calculated number of stocks to sell, as a bilateral transaction, and further transmits the sell-completed notice to the user terminal in response to the completion of transaction for the sell instruction.

In order to describe concrete contents of the calculation for the profit portion described above, a calculation of the profit portion in a sales transaction of an ordinary unit number of stocks (specified by the number of stocks) is first described. Profit from stocks is a difference between a contract price at the moment of selling ([a stock price at the moment of selling]×[the number of stocks sold]) and a contract price at the moment of purchase of the brand ([an average purchased stock price]×[the number of stocks sold]).

As one example, 100 shares of stocks were purchased at a stock price of 200 JPY in October (the contracted money amount was at 20,000 JPY, and the average purchased stock price at this moment was 200 JPY), and 100 shares of stocks of the same brand is then purchased in November. If the stock price as of November has gone up to 250 JPY, the contracted money amount which is required for the purchase is now 25,000 JPY (250 JPY×100 shares), and the average purchased stock price at the purchase in November becomes 225 JPY. Then, when selling off only 100 shares in December from the stocks purchased in October and November as described above, if the stock price at the moment of selling in December has further gone up to 270 JPY, the contracted money amount of the selling becomes 27,000 JPY (270 JPY×100 shares). Therefore, the profit portion is calculated as a difference of 4,500 JPY between 27,000 JPY of the contracted money amount for selling, and 22,500 JPY obtained by multiplying 225 JPY of the average purchased stock price at the latest purchase by 100 shares (27,000 JPY−22,500 JPY). Note that although an expense, such as a commission of the securities company, may be incurred in actual transaction, the expense such as the commission is eliminated from the consideration herein in order to simplify the description.

Thus, although it is common to trade stocks by specifying the number of stocks, some individual investors think that it is easier to recognize the details of trading if the trading unit is by the money amount rather than the number of stocks. Therefore, a trading service specified by the money amount has currently been provided in which an investor specifies the money amount in a stock trade, the securities company side counts backward to the number of stocks corresponding to the specified money amount to present it to the investor, and the investor then confirms the presented number of stocks and places an order. For example, if an investor wants to purchase stocks of a certain brand by 50,000 JPY, the securities company side calculates the purchasable number of stocks by dividing 50,000 JPY by the stock price at that moment.

Conducting the selling for the profit portion by operating the profit-portion sell button 35c of FIG. 7 which is a feature of the present invention is an application of the trading service specified by the money amount described above, where, when the sell instruction for the profit portion is given from an investor, the money amount of the profit portion at that moment is calculated, and the calculated profit portion is handled as the specified money amount in the trading service by specified by the money amount. The profit portion is obtained by deducting the expense required for the purchase of the total number of stocks (the capital required for the purchase, and corresponding to the contract price of buy) from the money amount which is obtained by multiplying the stock price at the time of calculation by the total number of stocks which the investor possesses (the money amount to be gained by selling off all the stocks, and corresponding to the contract price of sell).

Therefore, the trading program P11 defines that, when the sell instruction for the profit portion is received, the MPU 80a calculates the profit portion described above based on the trading information according to the specified brands corresponding to the instruction, in the user account table of the user who gave the instruction.

Note that profit which an investor recognizes may differ from profit on the taxation system. As described above, the investor may recognize the money amount which is obtained by deducting the contract price of purchase from the contract price of selling, as the profit. For example, in the example described above, 100 shares of stocks of which the stock price was 200 JPY were purchased in October, and 100 shares of stocks of the same brand were purchased in November (the stock price at the purchase in November was 250 JPY). If the stock price changes to 270 JPY in December, the investor recognizes that 9,000 JPY which is obtained by deducting the contract price of purchase (4,500 JPY=200 JPY×100 shares+250 JPY×100 shares) from the contract price of sell (50,000 JPY=270 JPY×200 shares) is the profit.

However, since the money amount obtained by deducting the contract price of purchase from the contract price of selling as described above (in the example, 9,000 JPY) falls under an act of selling off the fixed number of stocks containing profits, not all the money amount corresponds to taxable profit. For tax purposes, the profit is based on selling of the number of stocks which is counted backward, and in the example, since it is regarded as selling of the number of stocks (33.33 shares, and omitted at the third decimal place) which is obtained by dividing 9,000 JPY by the stock price as of December (270 JPY) for tax purposes, only the increased part of the price (a difference between the price at which the number of stocks was sold off and the expense required for the purchase) of the number of stocks (33.33 shares) becomes the taxable profit. In the example, 1,500 JPY which is obtained by deducting a multiplication of the average purchased stock price (225 JPY) in October and November by the number of stocks sold (33.33 shares), from a multiplication of the stock price at the sale in December (270 JPY) by the number of stocks sold (33.33 shares) becomes the taxable profit.

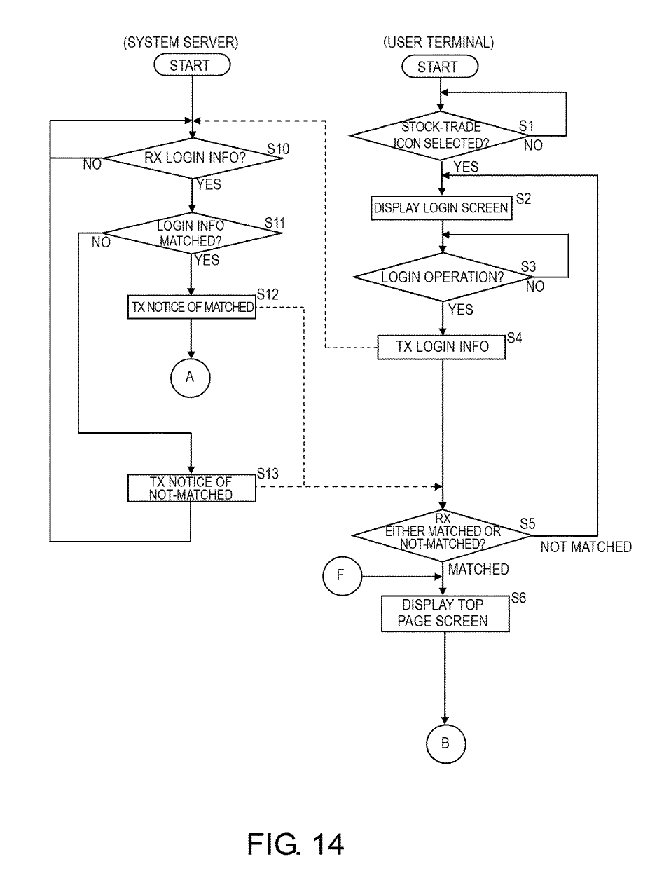

Moreover, although the selling off for the profit portion described above may alternatively be performed by the normal selling by specifying the number of stocks, since it will include the contents of calculation of the sell-for-profit-portion by specifying the money amount described above in the calculation process of the profit portion, the sell-for-profit-portion is ultimately dependent on the difference between the calculation based on the money amount and the calculation based on the number of stocks. Therefore, the sell-for-profit-portion by specifying the money amount conceptually includes the sell-for-profit-portion by specifying the number of stocks. Next, in response to the various processing steps performed respectively by the user terminal (e.g., the smartphone 10) and the securities company system 2 (the system server 80) described above, details of processing for the sales transactions of stocks which are executed in the financial product trading system 1 (details of the method of trading the financial product) are described based on 1st to 5th flowcharts FIGS. 14 to 18.

The 1st flowchart FIG. 14 illustrates a processing procedure when the user uses the user terminal to login to the securities company system 2 (the system server 80) which provides the online stock trading service. First, the user terminal (the CPU 10a) determines whether a selecting operation of the stock-trade icon 12 among the plurality of icons arranged in the home screen 11 illustrated in FIG. 3 is received (S1). If the selecting operation has not been received (S1: NO), the user terminal becomes in a state of waiting for the selection of the stock-trade icon 12, and on the other hand, if the selecting operation is received (S1: YES), the user terminal displays the login screen 15 illustrated in FIG. 4 (S2).

In this login screen 15, the user terminal determines the existence of the login operation, such as the input operation of an email address, the input operation of a password, and the selecting operation of the login button 15c (S3). If there is no login operation (S3: NO), it becomes in a state of waiting for the login operation. On the other hand, if there is a login operation (S3: YES), the user terminal transmits the login information (the information containing the email address and password which were entered, and the UID which identifies the user terminal) to the securities company system 2 (S4).

The system server 80 (the MPU 80a) of the securities company system 2 is at a stage of determining whether the login information has been received (S10), and if the login information has not been received (S10: NO), the system server 80 becomes in a state of waiting for the reception. On the other hand, if the login information is received (S11: YES), the system server 80 determines whether there are any email address and password in the information stored in the user DB 82 illustrated in FIG. 11 with corresponds to the email address and password contained in the received login information (S11). If matched information is not stored (S11: NO), the system server 80 transmits a notice of not-matched to the user terminal which is an accessing device (S13), and then returns to the first reception determination stage of the login information (S11), and on the other hand, the matched information is stored (S11: YES), the system server 80 transmits a notice of matching to the user terminal which is the accessing device (S12).

The user terminal determines which one of the notice of matching and the notice of not-matching is received after the transmission of the current login information at the stage of S4 (S5), and if the notice of not-matching is received (S5: not-matched), the user terminal returns to the stage of S2, where the login screen 15 is displayed again to provide the user with the opportunity of login. On the other hand, if the notice of matching is received (S5: matched), the user terminal displays the top page screen 20 of the stock trading application P2 illustrated in FIG. 5 (S6). The trading function of the stock trading application P2 becomes in an active state by the top page screen 20. Note that in this embodiment, once logged in, the login state continues until a logoff operation is performed, even if the screen based on the stock trading application P2 is switched to a screen of another application. While the login state is maintained, the processing illustrated in the 1st flowchart of FIG. 14 will not be repeated.

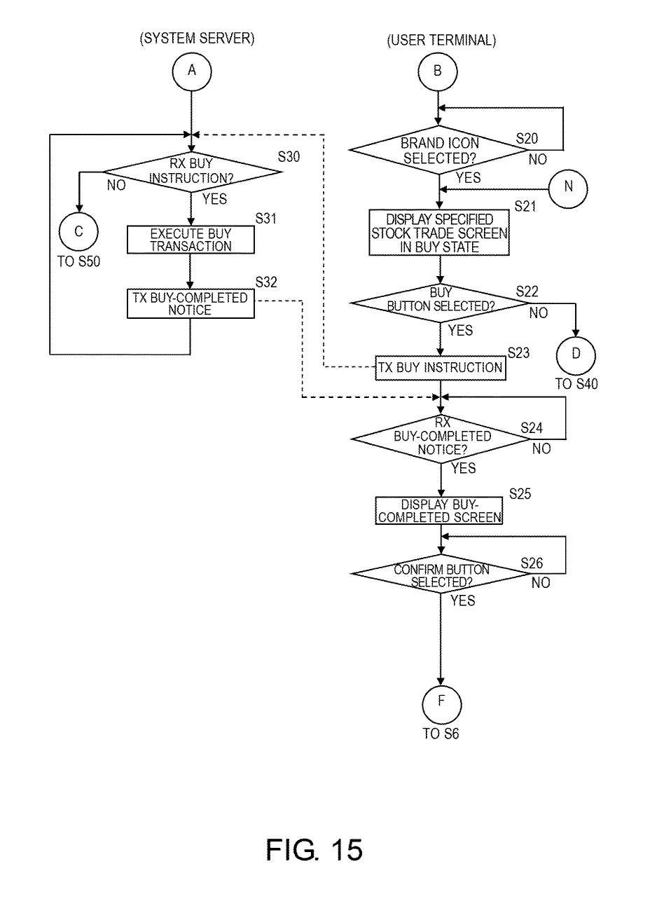

The 2nd flowchart of FIG. 15 illustrates details after the top page screen 20 is displayed on the user terminal. The user terminal determines whether a selecting operation of any one of the stock-trade icons 21a-21f (the brand icons) for Companies A to F arranged in the top page screen 20 is received (S20). If the selecting operation has not been received from the user (S20: NO), the user terminal becomes in a state of waiting for the selection, and on the other hand, if the selecting operation is received (S20: YES), the specified stock trade screen (FIG. 6) for the company of the selected icon is displayed in the buy transaction state (S21).

The user terminal determines whether a selecting operation of the buy button 30a is received after the money amount is set in the money-amount setting field 26e of the specified brand trade screen 25 by the user (S22). If the selecting operation of the buy button 30a is received (S22: YES), the user terminal transmits a buy instruction containing the information for identifying the brand (the brand ID), the money-amount information indicative of the money amount set in the money-amount setting field 26e, etc., to the securities company system 2 (S23).

Moreover, the system server 80 (the MPU 80a) of the securities company system 2 determines whether the buy instruction is received from the logged-in user terminal (S30). If the buy instruction is received (S30: YES), the system server 80 identifies the stock price (the latest stock price at the time of reception) of the brand contained in the buy instruction from the brand DB 81, calculates the purchasable number of stocks based on the money amount contained in the buy instruction, and executes a buy bilateral transaction within the tradable range of the number of stocks based on the calculated number of stocks (S31). Note that in association with the execution of buy transaction, the MPU 80a also stores contents of the processing in the account DB 83. The system server 80 (the MPU 80a) then transmits a buy-completed notice to the user terminal which is a sender of the buy instruction (S32).

After the transmission of the buy instruction at the stage of S23, the user terminal determines whether the buy-completed notice is received from the securities company system 2 (S24). If the buy-completed notice has not been received (S24: NO), the user terminal waits for the reception, and on the other hand, if the buy-completed notice is received (S24: YES), the user terminal displays the buy-completed screen 36 illustrated in FIG. 8(a) (S25). By the buy-completed screen 36, the user confirms that the buy instruction which is given by himself/herself is completed. The user terminal then determines whether the selecting operation of the confirmation button 36b in the buy-completed screen 36 is received (S26), and if the selecting operation has not been received (S26: NO), the user terminal becomes in a state of waiting for the selecting operation.

On the other hand, if the selecting operation of the confirmation button 36b is received (S26: YES), the user terminal returns to the stage of S6 in the 1st flowchart of FIG. 14, where the indication of the display unit 10g is switched from the buy-completed screen 36 to the top page screen 20 of FIG. 5 so that trading of other brands can be performed continuously.

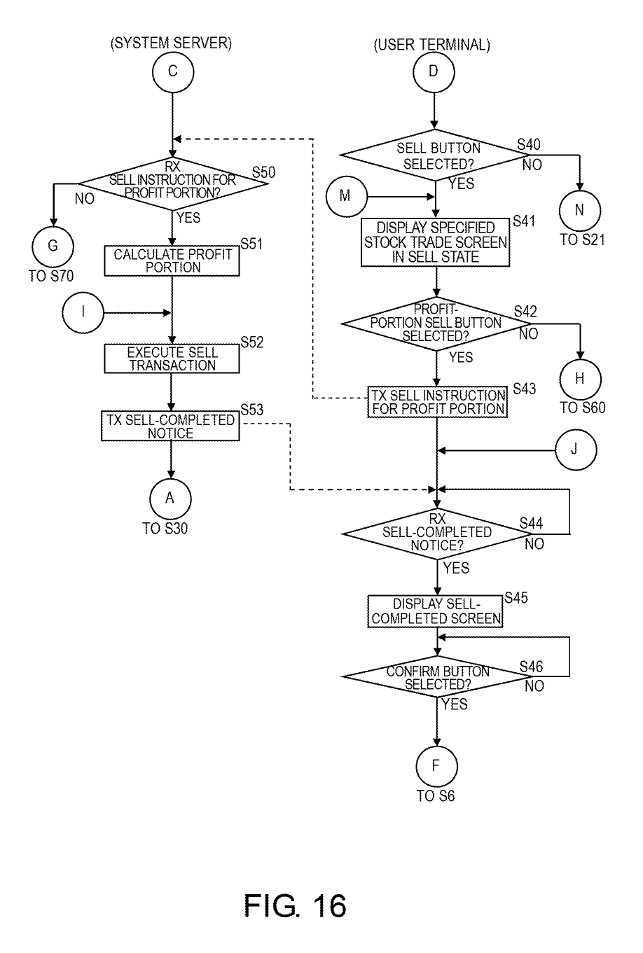

On the other hand, if the user terminal determines that the selecting operation of the buy button 30a has not been received at the stage of S22 (S22: NO), the user terminal transits to the 3rd flowchart of FIG. 16, and in this case, this means that the system server 80 of the securities company system 2 has neither received the buy instruction (S30: NO), the processing on the system server 80 side similarly proceeds to the 3rd flowchart of FIG. 16.

The 3rd flowchart of FIG. 16 mainly illustrates details of a sell transaction in the specified brand trade screen 25. The user terminal determines whether a selecting operation of the sell button 26b is received in the specified brand trade screen 25 in the buy transaction state (S40). If the selecting operation of the sell button 26b has not been received (S40: NO), the user terminal returns to the stage of S21 in FIG. 15, where the specified brand trade screen 25 continues being displayed in the buy transaction state. On the other hand, if the selecting operation of the sell button 26b is received (S40: YES), the specified brand trade screen 26 in the sell transaction state illustrated in FIG. 7 is displayed (S41).

The user terminal then determines whether the selecting operation of the profit-portion sell button 35c in the sell transaction part 35 near the center of the specified brand trade screen 25 (S42). If the selecting operation of the profit-portion sell button 35c is received (S42: YES), the user terminal transmits the sell instruction for a profit portion (including the brand ID of the brand corresponding to the specified brand trade screen 25) to the securities company system 2 (S43).

The system server 80 of the securities company system 2 determines whether the sell instruction for a profit portion is received from the logged-in user terminal (S50). If the system server 80 determines that the sell instruction for a profit portion is received (S50: YES), the system server 80 performs a sell transaction for the profit portion of the stocks of one particular brand (e.g., Company A) corresponding to the received sell instruction. Specifically, information on the brand corresponding to the brand ID contained in the received sell instruction for the profit portion is extracted from the logged-in user account table, the latest stock price corresponding to the brand ID is extracted from the brand DB 81 of FIG. 10, and the profit portion of the brand of the brand ID contained in the sell instruction is calculated by the calculating method described above based on the extracted information (S51).

The system server 80 then executes a sell bilateral transaction by the number of stocks based on the calculated profit portion, for the brand of the brand ID contained in the sell instruction (S52). Note that in association with the execution of the sell transaction, contents of the processing are stored in the account DB 83. The system server 80 (the MPU 80a) then transmits a buy-completed notice to the user terminal which is a sender of the sell instruction (S53). Note that after the transmission of the sell-completed notice, the processing of the system server 80 returns to the first step (S30) in the 2nd flowchart of FIG. 15.

After the transmission of the sell instruction for the profit portion at the stage of S43, the user terminal determines whether the sell-completed notice is received from the securities company system 2 (S44). If the sell-completed notice has not been received (S44: NO), the user terminal waits for the reception, and on the other hand, if the sell-completed notice is received (S44: YES), the user terminal displays the sell-completed screen 37 illustrated in FIG. 8(b) (S45). By the sell-completed screen 37, the user confirms that the sell instruction for the profit portion which is given by himself/herself is completed. The user terminal then determines whether a selecting operation of the confirmation button 37b of the sell-completed screen 37 is received (S46), and if the selecting operation has not been received (S46: NO), the user terminal becomes in a state of waiting for the selecting operation.

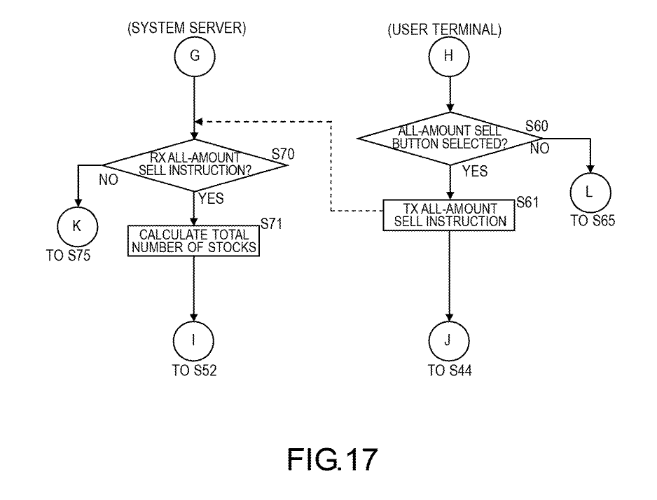

If the selecting operation of the confirmation button 37b is received (S46: YES), the user terminal returns to step S6 in the 1st flowchart FIG. 14, and the user terminal displays the top page screen 20 so that trading of another brand can continuously be performed. On the other hand, if the user terminal determines that the selecting operation of the profit-portion sell button 35c has not been received at step S42 (S42: NO), the user terminal transits to the 4th flowchart FIG. 17, and in this case, this means that the system server 80 of the securities company system 2 has neither been received the sell instruction for the profit portion (S50: NO), the processing on the system server 80 side similarly proceeds to the 4th flowchart FIG. 17.

The 4th flowchart FIG. 17 relates to the sell-all in a sell transaction. The user terminal determines whether a selecting operation of the all-amount sell button 35b in the sell transaction part 35 near the center of the specified brand trade screen 25 is received (S60). If the selecting operation of the all-amount sell button 35b is received (S60: YES), the user terminal transmits the all-amount sell instruction (including the brand ID of the brand according to the specified brand trade screen 25) to the securities company system 2 (S61).

The system server 80 of the securities company system 2 determines whether the all-amount sell instruction is received from the logged-in user terminal (S70). If the system server 80 determines that the all-amount sell instruction is received (S70: YES), it extracts information on the brand corresponding to the brand ID contained in the received all-amount sell instruction from the logged-in user account table, and calculates the total number of stocks based on the extracted information (S71). Subsequent processing steps are equivalent to the processing steps at and after step S52 in the 3rd flowchart of FIG. 16, where a series of processing steps including a sell transaction of the calculated total number of stocks, etc. are performed. The processing steps on the user terminal side are also equivalent to the processing steps at and after step S44 in the 3rd flowchart of FIG. 16 after the transmission of the all-amount sell instruction (after S61).

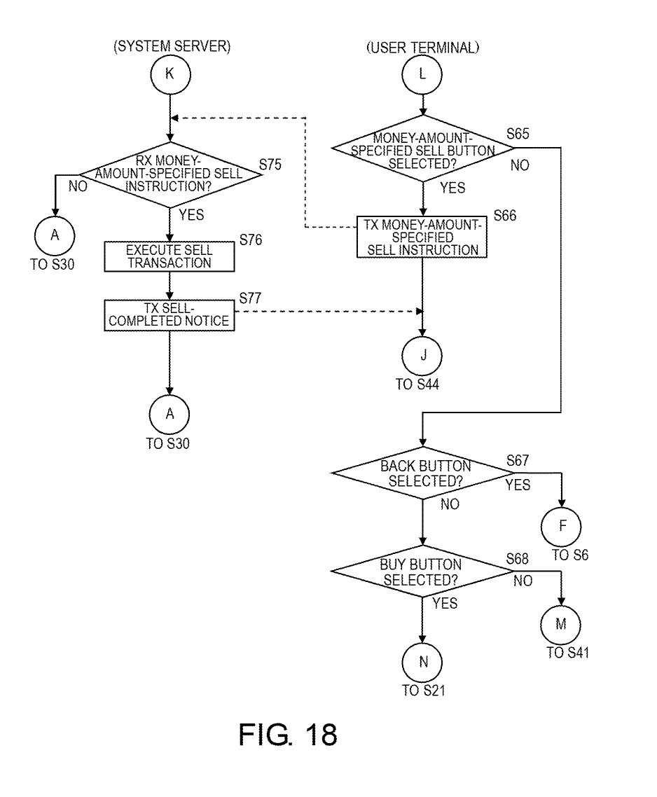

On the other hand, if the user terminal determines that the selecting operation of the all-amount sell button 35b has not been received at the stage of S60 (S60: NO), the user terminal proceeds to the 5th flowchart of FIG. 18, and in this case, this means that the system server 80 of the securities company system 2 has neither been received the all-amount sell instruction (S70: NO), and thus, the processing on the system server 80 side similarly proceeds to the 5th flowchart of FIG. 18.

The 5th flowchart of FIG. 18 relates to the selling for the money amount being specified in the sell transaction. The user terminal determines whether the money amount is set by the user in the money-amount setting field 26e of the specified brand trade screen 25, and a selecting operation of the money-amount-specified sell button 35a in the sell transaction part 35 near the center of the screen is received (S65). If the selecting operation of the money-amount-specified sell button 35a is received (S65: YES), the user terminal transmits a money-amount-specified sell instruction containing the information for identifying the brand (the brand ID) and the money-amount information indicative of the money amount set in the money-amount setting field 26e, to the securities company system 2 (S66).

The system server 80 of the securities company system 2 determines whether the money-amount-specified sell instruction is received from the logged-in user terminal (S75). If the system server 80 determines that the money-amount-specified sell instruction is received (S75: YES), the system server 80 identifies the stock price (the latest stock price at the time of reception) of the brand contained in the sell instruction among the brand DB 81, calculates the sellable number of stocks based on the money amount contained in the sell instruction, and performs a sell bilateral transaction for the tradable unit of the number of stocks according to the calculated number of stocks (S76). The system server 80 (the MPU 80a) then transmits a sell-completed notice to the user terminal which is a sender of the sell instruction (S77), and the processing of the system server 80 then returns to the first step (S30) in the 2nd flowchart of FIG. 15.

After transmitting the money-amount-specified sell instruction at step S66 on the user terminal side, the processing steps are equivalent to the processing steps at and after step S44 in the 3rd flowchart FIG. 16. On the other hand, at the stage of S65, if the selecting operation of the money-amount-specified sell button 35a is not performed (S65: NO), the user terminal determines whether the selecting operation of the back button 25g in the specified brand trade screen 25 of FIG. 7 is received (S67). If the selecting operation of the back button 25g has not been received (S67: NO), the user terminal determines whether the selecting operation of the buy button 26a is received (S68). If the selecting operation of the buy button 26b has not been received (S68: NO), the user terminal returns the process to step S41 in the 3rd flowchart of FIG. 16 (the display stage of the specified brand trade screen 25 in the sell transaction state). If the selecting operation of the buy button 26b is received (S68: YES), the user terminal returns the processing to step S21 in the 2nd flowchart FIG. 15 (the display stage of the specified brand trade screen 25 in the buy transaction state). In addition, if the selecting operation of the back button 25g is received (S67: YES), the user terminal returns the process to step S6 in the 1st flowchart FIG. 14 (the display stage of the top page screen 20). Note that if the money-amount-specified sell instruction has not been received at the step S75 on the system server side (S75: NO), the system server side returns the process to step S30 in the 2nd flowchart FIG. 15.

Thus, in the invention according to Embodiment 1, first, as a transition of the displayed contents of the screen, when the icon (21a-21f) of the brand desired to trade is selected in the top page screen 20 of FIG. 5, the display is switched to the specified brand trade screen 25 (see FIG. 6) dedicated to the selected one particular brand. Therefore, the investor (user) can concentrate on the contents of buy/sell transactions thereafter without caring about the brand.

Moreover, in the specified brand trade screen 25 in the buy transaction state of FIG. 6, the settable money amount in the money-amount setting field 26e is based on the unit of 10,000 JPY, and a given money amount is settable by the unit of 10,000 JPY (the configuration of the picker which rotates like the slot machine to set the money amount in FIG. 6). Therefore, fine tuning of the money-amount input operation is unnecessary, and the investor (user) is able to quickly give the buy instruction without missing the timing of a suitable stock price for the buy transaction.

Further, in the specified brand trade screen 25 in the sell transaction state of FIG. 7, since the buttons of three patterns which enable the sell instructions by the one-touch operation, such as the money-amount-specified sell button 35a, the all-amount sell button 35b, and the profit-portion sell button 35c, are provided, they are applicable to wide variety of situations of the sell instruction by the user. Particularly, when giving an instruction by operating the all-amount sell button 35b or the profit-portion sell button 35c, setting of the money amount is unnecessary. Therefore, a sell instruction can quickly be given without missing the timing of a suitable stock price for the sell transaction. Moreover, even when operating the money-amount-specified sell button 35a, since the fine money-amount input operation is unnecessary, an accordingly quick sell instruction can be given.

Note that Embodiment 1 of the present invention is not limited to the details described above, and various modifications may be considered. For example, other than transiting from the top page screen 20 (the icon screen) where the plurality of icons 21a-21f are arranged as illustrated in FIG. 5 to the specified brand trade screen 25 illustrated in FIGS. 6 and 7, the indication may be configured to transit from the list screen of brands to the specified brand trade screen 25 by selecting one of the brands from the list screen which indicates the transacted brands in the past. Moreover, if the configuration of the specified brand trade screen 25 illustrated in FIGS. 6 and 7 is to be simplified, the arrangement of the second common part 27 in the specified brand trade screen 25 may be omitted. Therefore, information to be presented to the user can be lessened so as to increase a degree of leaving to the user with the determination. Note that if the configuration of the specified brand trade screen 25 in the sell transaction state is to be further simplified, the sell instruction function based on the money-amount-specified sell button 35a may be omitted, and in this case, the arrangement of the money-amount setting field 26e of the first common part, the money-amount-specified sell button 35a, etc. is omitted. If the configuration is to be further simplified, the arrangement of the all-amount sell button 35b may be omitted, and in this case, since the investor (user) concentrates only on the sell-for-profit-portion, it is advantageous for him/her to be able to concentrate on the determination within the very-limited range.

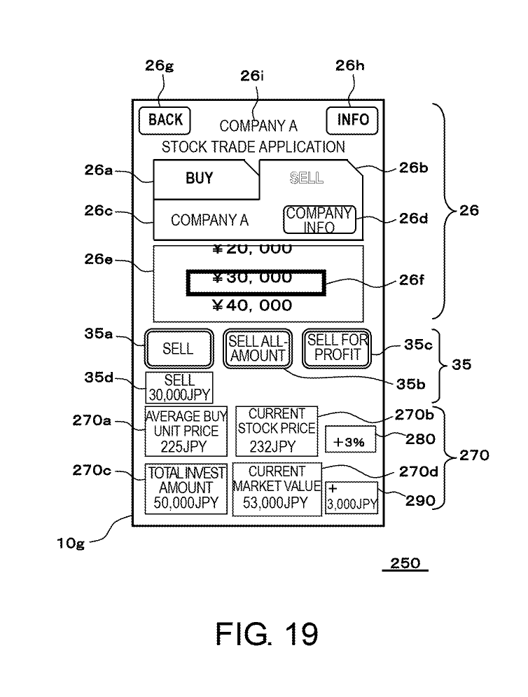

Meanwhile, FIG. 19 illustrates screen contents of a specified brand trade screen 250 of one modification in which an information volume of the specified brand trade screen 25 is increased. In this modification, a percentage variation field 280 indicative of a change in the current stock price to the average buy unit price at which the logged-in user purchased the particular brand of stocks so far (the stocks of Company A in the case illustrated in FIG. 19) is provided to the right of an average buy unit price field 270a and a current stock price field 270b in a second common part 270, and a current profit-and-loss field 290 indicative of an amount of profit/loss at the time of displaying the screen is provided to the right of a total investment amount field 270c and a current market value field 270d. The information indicated in the percentage variation field 280 (a numeral indicative of percentage with a sign of +/−, where + indicates a rise of the unit price from the time of purchase, and − indicates a fall of the unit price fall from the time of purchase), and the information indicated in the current profit-and-loss field 290 (a profit-and-loss according to the money amount with +/−, where + indicates profit caused, and − indicates loss caused) are extracted from the information which was transmitted to the smartphone 10 and acquired from the securities company system 2 in association with the completion of login, similar to the numerical value indicated in each field, such as the average buy unit price field 270a. Among the variety of information temporarily stored in the RAM 10c, the information related to the stocks of Company A is extracted in response to the selection of the stock-trade icon 21a of Company A, and is then arranged in the fields 270a-270d, 280, and 290.

Like this modification, if the percentage variation field 280 and the current profit-and-loss field 290 are provided, it becomes suitable especially when giving a sell instruction by the all-amount sell button 35b and the profit-portion sell button 35c. That is, when a case where a sell instruction is given by the all-amount sell button 35b is assumed, the investor (user) can confirm the outline of increases and decreases in the average of the stock prices purchased in the past and the current stock price in the percentage variation field 280, and confirms the current profit in the current profit-and-loss field 290. Therefore, the information is usable as an indicator to determine whether the selling for all amount is to be performed. Similarly, if a case where a sell instruction is given by the all-amount sell button 35b is assumed, since the investor (user) can confirm the current profit in the current profit-and-loss field 290, he/she can determine based on the information whether the sell for the profit portion is to be performed.

Note that in order to display the information in the percentage variation field 280 and the current profit-and-loss field 290 described above, the system server 80 of the securities company system 2 needs to generate and transmit the information to be arranged in the fields 280 and 290. The system server 80 identifies the user account table corresponding to the user ID of the user who completed a login, calculates the percentage variation of each brand for the logged-in user based on the information stored in the brand DB 81, calculates the current profit and loss of each brand, and transmits information including the calculated results to the user terminal (e.g., the smartphone 10).

Moreover, new fields may be added to the second common parts 27 and 270 to further enrich the contents, and as the new fields to be added may be an average foreign exchange field, a current foreign exchange field, etc. Such fields may be suitable because sales transactions become easier for the investor (user) to perform while taking into consideration a relation with the money unit of his/her own country, if the brands are foreign (e.g., U.S.) stocks and the information on the exchange with overseas countries is displayed in the average foreign exchange field and the current foreign exchange field. Note that if trading the overseas brands, the number of stocks to be traded etc. may be calculated after the system server 80 etc. suitably performing the exchange processing between the currency of the country set in the screen and the currency of a target country for trading, in the profit-portion calculation, etc. described above. Such information on foreign exchange may be acquired by the user terminal (the smartphone 10, etc.) directly from the information collecting system 3, or may be acquired by the securities company system 2 and then transmitted to the user terminal.

Further, as one modification in which the omission of the second common part 27 described above and the display of the second common part 27 are combined, the second common part 27 may be switchable between being displayed/not-displayed. In this case, a selecting part (a button) for receiving a switching instruction between displaying and not-displaying the second common part 27 may be provided in the specified brand trade screen 25, and the displaying/not-displaying of the second common part 27 may be switched according to the selecting situation of the button.

Further, in the description described above, the buy instruction 30a is transmitted to the securities company system 2 when the buy button 30a is selected, and the sell instruction is transmitted to the securities company when each of the sell buttons 35a-35c is selected. However, information for confirming details of the buy transaction or details of the sell transaction may be presented, and the buy or sell instruction may be transmitted when the user performs a confirming operation with respect to the presentation.

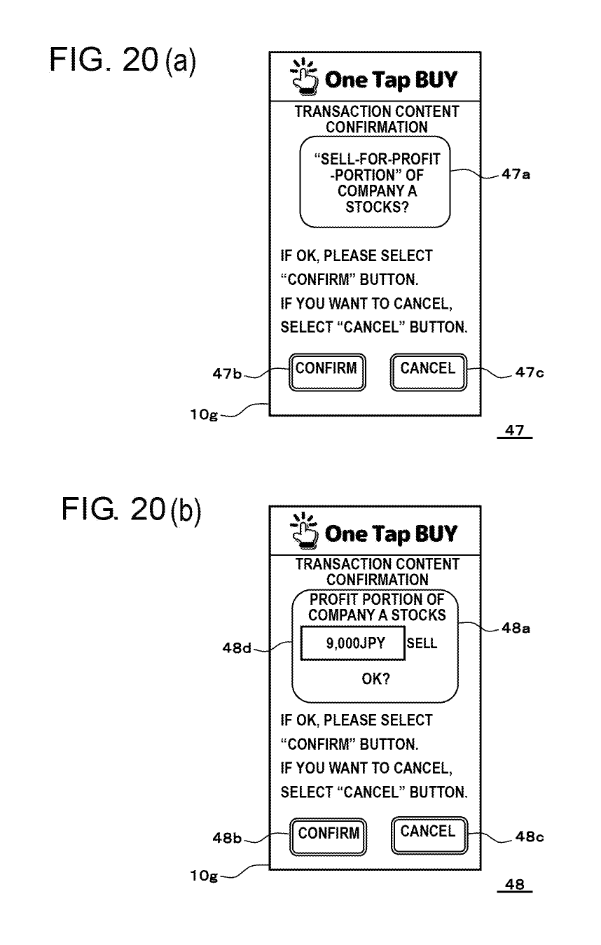

FIG. 20(a) illustrates one example of a concrete confirmation screen of the modification where the information for confirming the details of the sell transaction is presented, and illustrates a sell-for-profit-portion confirmation screen 47 which is displayed when the profit-portion sell button 35c is selected. The sell-for-profit-portion confirmation screen 47 is displayed by being switched from the specified brand trade screen 25 in response to the selection of the profit-portion sell button 35c, where a text part 47a for confirming the sell-for-profit-portion, a selectable confirmation button 47b (corresponding to a sell confirmation operating part), and a cancel button 47c are arranged.

In such a case where the sell-for-profit-portion confirmation screen 47 is displayed, a confirmed instruction (decided instruction) of the sell-for-profit-portion is transmitted to the securities company system 2 when the user terminal receives a selecting operation of the confirmation button 47b. Therefore, there is an advantage in that the sell instruction is transmitted after the user's intention is confirmed. Moreover, when a selecting operation of the cancel button 47c of the sell-for-profit-portion confirmation screen 47 is received, the user terminal returns the indication back to the specified brand trade screen in the sell transaction state which was displayed immediately before, and a state where any one of the three patterns of sell buttons 35a-35c is selectable is again presented to the user. Note that the sell-for-profit-portion confirmation screen 47 of FIG. 20(a) is one example when the profit-portion sell button 35b is selected. However, also when the money-amount-specified sell button 35a or the all-amount sell button 35b is selected, a corresponding sell confirmation screen is displayed, respectively (with a screen configuration in which the text part indicates contents of the specified-by-money-amount or the sell-all-amount, and a confirmation button and a cancel button similar to those in FIG. 20(a) are arranged).

Further, such a screen indication according to the sell confirmation screen 47 may of course be displayed at the time of buy transaction, and, for example, when the buy button 30a is selected in the specified brand trade screen 25 in the buy transaction state illustrated in FIG. 6, a buy confirmation screen corresponding to the sell confirmation screen 47 is displayed. In order to display the buy/sell confirmation screen, the stock trading application P2 installed in the user terminal (e.g., the smartphone 10) may define processing for the buy/sell confirmation screen, and the CPU 10a may perform various types of processing.

Alternatively, a sell-for-profit-portion confirmation screen 48 illustrated in FIG. 20(b) illustrates one modification of the sell-for-profit-portion confirmation screen 47 of FIG. 20(a) described above. This sell-for-profit-portion confirmation screen 48 has a feature to present the profit portion which is calculated based on the stock price when a selecting operation of the profit-portion sell button 35b is performed in the specified brand trade screen 25 in the sell transaction state of FIG. 7. That is, in the sell-for-profit-portion confirmation screen 48 of this modification, a money-amount indication field 48d indicative of the profit portion which is calculated based on the latest stock price is arranged in a text part 48a for confirming the sell-for-profit-portion. Note that a confirmation button 48b and a cancel button 48c in the sell-for-profit-portion confirmation screen 48 of this modification are equivalent to the confirmation button 47b and the cancel button 47c of the sell-for-profit-portion confirmation screen 47 illustrated in FIG. 20(a).

The sell-for-profit-portion confirmation screen 48 of this modification has an advantage in that, by displaying the sell-for-profit-portion confirmation screen 48 of FIG. 20(b), the investor (user) is able to confirm the profit portion indicated in the money-amount indication field 48d and then finally determine whether the sell transaction is to be conducted. In order to display such a sell-for-profit-portion confirmation screen 48 of this modification on the user terminal, the stock trading application P2 on the user terminal side and the trading program P11 on the system server 80 side are necessary to newly define processing related to the sell-for-profit-portion confirmation screen 48 so that the user terminal (e.g., the CPU 10a of the smartphone 10) and the MPU 80a of the system server 80 performs processing for the new display according to such a definition.

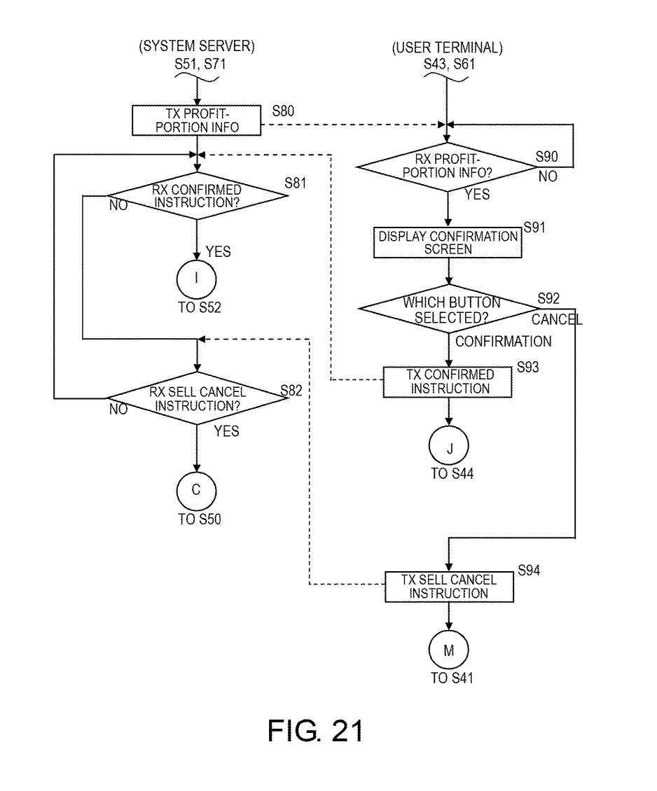

The 6th flowchart of FIG. 21 illustrates details of a processing procedure (the method of trading the financial product) by the user terminal and the system server 80 for displaying the sell-for-profit-portion confirmation screen 48 of FIG. 20(b), and illustrates details of processing steps which are added to the 3rd flowchart of FIG. 16 after step S43 on the user terminal side and after step S51 on the system server 80 side. That is, the 6th flowchart of FIG. 21 illustrates the details of processing steps that are added to the 3rd flowchart of FIG. 16 after the profit-portion sell button 35c is selected in the specified brand trade screen 25 in the sell transaction state of FIG. 7 (S42: YES) and the sell instruction for a profit portion is then transmitted to the system server 80 (S43), and after the system server 80 calculates the profit portion (S51) in response to the reception of the sell instruction for a profit portion (S50: YES).

In the 6th flowchart of this FIG. 21, the system server 80 transmits the profit-portion information indicative of the calculated profit portion to the user terminal which is a sender of the sell instruction for a profit portion (S80). The user terminal determines whether the profit-portion information is received (S90). If the profit-portion information has not been received (S90: NO), the user terminal waits for the reception of the profit-portion information, and on the other hand, if the profit-portion information is received (S90: YES), the user terminal displays the sell-for-profit-portion confirmation screen 48 (S91). As illustrated in FIG. 20(b), the sell-for-profit-portion confirmation screen 48 to be displayed indicates the profit corresponding to the received profit-portion information in the money-amount indication field 48d, and includes the confirmation button 48b (corresponding to the sell confirmation operating part) which is receivable of the user operation corresponding to the decided instruction for the sell-for-profit-portion. The user terminal then determines whether a selecting operation of the confirmation button 48b or the cancel button 48c is performed in the sell-for-profit-portion confirmation screen 48 (S92).

If the selecting operation of the confirmation button 48b is performed (S92: the confirmation button), the user terminal transmits the confirmed instruction (decided instruction) for the sell instruction for a profit portion to the system server 80 (S93). Note that after step S93 of the user terminal, the processing proceeds to step S44 in the 3rd flowchart of FIG. 16. The system server 80 is at the stage of determining whether the confirmed instruction has been received (S81). If the confirmed instruction is received (S81: YES), the system server 80 proceeds to step S52 in the 3rd flowchart of FIG. 16, where the sell transaction is performed (S52). Note that the processing after step S52 of the system server 80 follows the 3rd flowchart of FIG. 16.

On the other hand, at the step S92, if the selecting operation of the cancel button 48c is performed (S92: the cancel button), the user terminal transmits a sell cancel instruction to the system server 80 (S94). Note that after step S94 of the user terminal, the processing proceeds to step S41 in the 3rd flowchart of FIG. 16, where the sell-for-profit-portion confirmation screen 48 is switched to the specified brand trade screen 25 in the sell transaction state of FIG. 7.

If the confirmed sell instruction has not been received (S81: NO), at the stage of determining whether the decided sell instruction has been received of S81, the system server 80 then determines whether the sell cancel instruction is received (S82). If the sell cancel instruction has not been received (S82: NO), the system server 80 again returns to step S81. On the other hand, if the sell cancel instruction is received (S82: YES), the system server 80 returns to step S50 in the 3rd flowchart of FIG. 16, and then follows the 3rd flowchart of FIG. 16.

Note that in the case where the specified brand trade screen 250 of the modification of FIG. 19 is applied, since the profit portion is illustrated in the current profit-and-loss field 290, the user terminal side acquires the information on the profit portion even if the processing illustrated in the 6th flowchart of FIG. 21 described above is not performed. Thus, the user terminal side is possible to indicate the money amount according to the already-acquired information on the profit portion in the money-amount indication field 48d of the sell-for-profit-portion confirmation screen 48 of FIG. 20(b). However, if time has passed since login, the stock price may be changed from the price at login. Therefore, it is more suitable to perform the processing illustrated in the 6th flowchart of FIG. 21 described above and acquire the information on the profit portion based on the latest stock price.

Moreover, the contents of the sell-for-profit-portion confirmation screen 48 of FIG. 20(b) and the 6th flowchart of FIG. 21 is also applicable to the case where the all-amount sell button 35b is selected in the specified brand trade screen 25 in the sell transaction state of FIG. 7, and an all-amount sell confirmation screen containing the money-amount indication field indicative of the total amount is displayed. In this case, the processing at and after S90 on the user terminal side in the 6th flowchart of FIG. 21 are added after the stage of S61 on the user terminal side in the 4th flowchart illustrated in FIG. 17, and the processing step at and after S80 on the system server 80 side in the 6th flowchart of FIG. 21 are added after step S71 on the system server 80 side in the 4th flowchart illustrated in FIG. 17. Thus, also in the all-amount sell confirmation screen, since the money amount corresponding to the total amount is presented, it becomes suitable in that the final opportunity to determine whether to perform the all-amount sell transaction is given to the investor (user).

Note that the indication of the money amount for trading like the sell-for-profit-portion confirmation screen 48 of FIG. 20(b) is also applicable to the sell confirmation screen which is displayed in response to the selection of the money-amount-specified sell button 35a. In this case, since the money amount for trading is set on the user terminal side, the money amount is indicated in the money-amount indication field of the sell confirmation screen as it is, without communicating with the system server 80. Similarly, the set money amount may also be displayed in the buy confirmation screen which is displayed when the buy button 30a is selected so that the investor (user) is given an opportunity to finally confirm the money amount for the selling/buying.

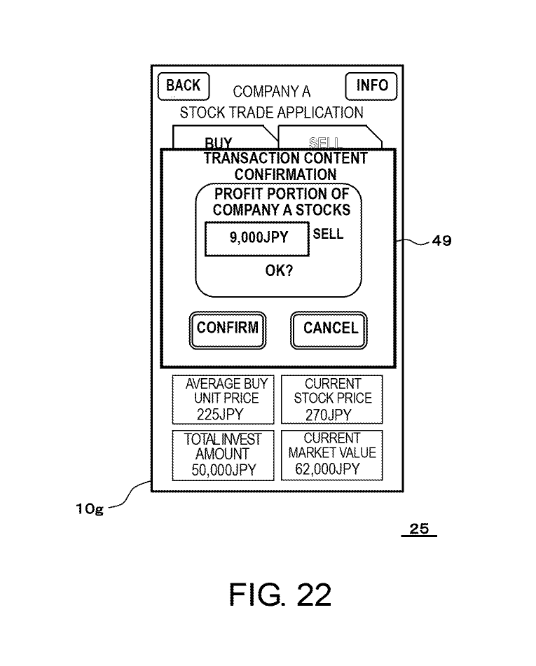

FIG. 22 illustrates a further modification of the confirmation screens illustrated in FIG. 20, etc. In the case described above, the screen is switched from the specified brand trade screen 25 to display the confirmation screens 47 and 48 illustrated in FIGS. 20(a) and (b), respectively. On the other hand, the modification of FIG. 22 has a feature in which a window 49 (may also be referred to as a “dialog” instead of the window) is displayed so as to overlap with the specified brand trade screen 25, and contents equivalent to one of the confirmation screens 47 and 48, etc. described above is arranged in the window 49. Thus, it becomes suitable in that the contents equivalent to the confirmation screens 47 and 48 are displayed in the window 49, and the specified brand trade screen 25 can be confirmed in the part where the window 49 is not overlapped.

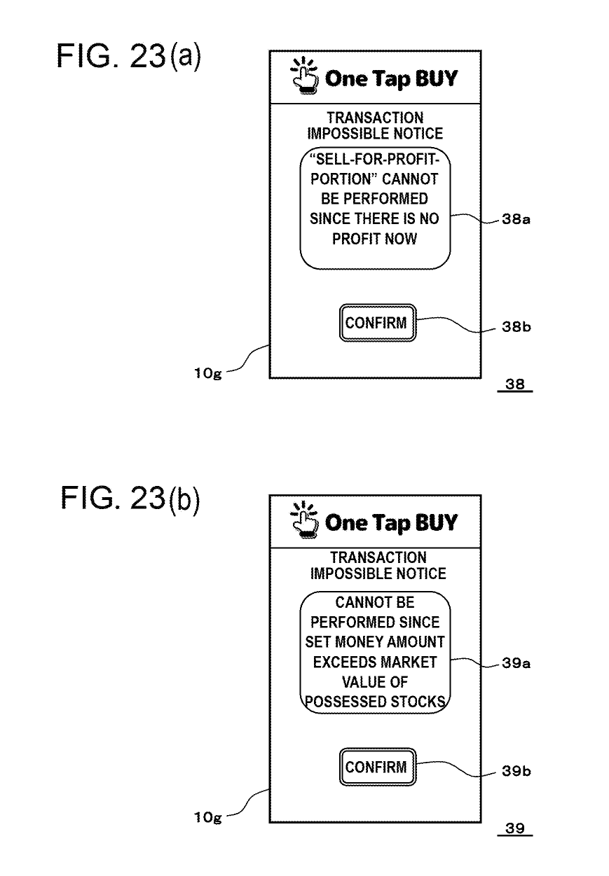

Moreover, a confirmation screen 38 illustrated in FIG. 23(a) is displayed instead of the sell-completed screen 37 of FIG. 8(b), and it is a modification in which the confirmation screen 38 is displayed on the user terminal in response to the selection of the profit-portion sell button 35c in the specified brand trade screen 25 in the sell transaction state of FIG. 7 if there is no profit portion.

That is, since there may be no profit portion when the investor (user) tries to sell the profit portion, the system server 80 calculates the profit portion at step S51 in the 3rd flowchart of FIG. 16, and if the profit portion is a minus value, it transmits, at step S53, a notice of minus profit portion instead of the sell-completed notice, without performing the sell transaction of step S52. Then, when the user terminal side receives the notice of minus profit portion, it displays the confirmation screen 38 illustrated in FIG. 23(a).

The confirmation screen 38 includes a text part 38a indicating that a sell-for-profit-portion order cannot be placed since there is no profit portion, and a selectable confirmation button 38b. When a selecting operation of the confirmation button 38b is performed, the specified brand trade screen 25 in the sell transaction state of FIG. 7 is displayed. In order to display such a confirmation screen 38, the processing related to the confirmation screen 38 is necessary to be newly defined in the stock trading application P2 on the user terminal side, and the trading program P11 on the system server 80 side so that the user terminal (e.g., the CPU 10a of the smartphone 10) and the MPU 80a of the system server 80 perform the processing related to the display of the confirmation screen 38 according to such a definition.

Note that if there is no profit portion, the screen may be switched to a state where the profit-portion sell button 35c is not selectable (inactive state) in the specified brand trade screen 25 in the sell transaction state of FIG. 7, other than displaying the confirmation screen 38 illustrated in FIG. 23(b). Thus, in order to prevent from selecting the profit-portion sell button 35c, for example, in a case where the specified brand trade screen 250 of FIG. 19 is applied, since the profit portion is indicated in the current profit-and-loss field 290 beforehand, the specified brand trade screen 25 in the sell transaction state where the profit-portion sell button 35c is not selectable is displayed if the profit portion is minus at this moment. Moreover, in this case, it becomes suitable if a message indicating that the profit-portion sell button 35c is not selectable because there is no profit portion displayed when a screen part corresponding to the profit-portion sell button 35c is touched by the user, since the reason of the button not being selectable is explained to the user.

Moreover, a confirmation screen 39 illustrated in FIG. 23(b) is also displayed instead of the sell-completed screen 37 of FIG. 8(b), and it is a modification in which the confirmation screen 39 is displayed on the user terminal at a timing where the money-amount-specified sell button 35a is selected in the specified brand trade screen 25 in the sell transaction state of FIG. 7, if a sell instruction set with a money amount exceeding the stock price possessed by the investor is given.

That is, since the investor (user) may set the money amount exceeding the market value of the brand possessed by the investor in the money-amount setting field 25e, the market value of the total number of stocks possessed by the investor is compared with the money amount contained in the sell instruction at step S76 in the 5th flowchart of FIG. 18, and a sell-impossible notice is transmitted at step S77 instead of the sell-completed notice, without performing a sell transaction, if the money amount contained in the sell instruction exceeds the market value of the total number of stocks. The user terminal side displays the confirmation screen 39 illustrated in FIG. 23(b) when the sell-impossible notice is received.

The confirmation screen 39 includes a text part 39a indicating that the sell transaction cannot be performed since the set money amount exceeds the market value of the total number of stocks possessed by the user, and a selectable confirmation button 39b, and when a selecting operation of the confirmation button 39b is performed, the specified brand trade screen 25 in the sell transaction state of FIG. 7 is displayed. In order to display such a confirmation screen 39, the processing related to the confirmation screen 39 is necessary to be newly defined in the stock trading application P2 on the user terminal side and the trading program P11 on the system server 80 side so that the user terminal (e.g., the CPU 10a of the smartphone 10) and the MPU 80a of the system server 80 perform the processing for displaying the confirmation screen 39 according to such a definition.

Note that it may be configured so that the money amount exceeding the money amount of the total number of stocks possessed by the user cannot be set in the money-amount setting field 25e, instead of displaying the confirmation screen 39 of FIG. 23(b). In this case, as for a user who completed a login, the system server 80 calculates beforehand a maximum value of the money amount which can be set for each brand from the user account table of the user, and notifies the calculated maximum value to the user terminal. The user terminal side stores the notified maximum value in the RAM 10c, etc., and when displaying the specified brand trade screen 25 in the sell transaction state of FIG. 7, reads the maximum value for the particular brand of stocks to prevent the money-amount setting field 25e from being set with the money amount exceeding the maximum value. Specifically, it is possible to limit a setting range of the money amount by disabling a range which rotates like the slot machine so that it cannot be rotated toward the money amount exceeding the maximum value.

Moreover, the unit of money amount which can be set in the money-amount setting field 25e in the specified brand trade screen 25 of FIGS. 6 and 7 may be, other than the unit of 10,000 JPY, the unit of 1,000 JPY in which at least the first to the third digits of the money amount are 0 (a unit in which the third or less digits are 0), the unit of 100 JPY in which the first to the second digits are 0 (a unit in which the second or less digits are 0), or the unit of 10 JPY in the first digit is 0. Further, as the financial product which can be handled by the present invention, stocks in the world, etc. are applicable, and in this case, as the types of money which is set for buying/selling in the brand trade screen 25, U.S. Dollar (USD), Canadian Dollar (CAD), the EU's Euro (EUR), Brazilian Real (BRL), Australian Dollar (AUD), Chinese Yuan Renminbi (CNY), Great United Kingdom's Pound Sterling (GBP), South Korean Won (KPW), New Zealand Dollar (NZD), Singapore Dollar (SGD), South African Rand (ZAR), Hong Kong Dollar (HKD), Thailand Baht (THB), Swiss Franc (CHF), Indian Rupee (INR), Russian Ruble (RUB), Philippine Peso (PHP), Indonesian Rupiah (IDR), etc. may be used other than Japanese Yen (JPY). In that case, in order to reduce the setting and inputting load of the money amount, it may be suitable if the unit of money amount is set so that at least the first digit of the money amount is 0 for overseas currencies if which the unit of money amount is greater than 100 JPY of Japanese Yen (Dollar, Euro, etc.). Moreover, if using the unit of money amount of such an overseas currency, the processing related to the currency exchange is suitably performed by the system server 80, as described above.

In the present invention, it is also possible to receive a transaction instruction by the number of stocks, other than receiving a user's transaction instruction by the money amount, as described above, and in this case, the money-amount setting field 26e in the specified brand trade screen 25 of FIGS. 6 and 7 is switched to a number-of-stocks setting field. Further, the present invention is also applicable to executing trading by a brokerage transaction, other than the bilateral transaction executed by the securities company system 2 (a case where a transaction is executed in the financial product exchange according to the exchange system 4, etc. is assumed). Further, the candidates for trading of the present invention is also applicable to financial products other than stocks described above, which may specifically be securities, such as bonds, real estate securities, and securities of investment trusts, or derivatives (financial derivatives), such as futures transactions, CFDs (Contracts for Difference), and share options, and the details described above is applicable to those of the candidates which correspond to the particular brands of stocks.

### Embodiment 2

A financial product trading system according to Embodiment 2 of the present invention displays the various screens according to Embodiment 1 described above on the user terminals on a website basis. Note that also in Embodiment 2, since the hardware configuration is similar to that of Embodiment 1, details of Embodiment 2 are described below while using the same reference numerals as those of Embodiment 1.

In Embodiment 2, the securities company system 2 establishes a stock trade website on a network NW, and the system server 80 included in the securities company system 2 functions as a web server so that the various screens described in Embodiment 1 are displayed on the user terminal via the website according to accesses from the user terminal to perform the buy/sell transactions.

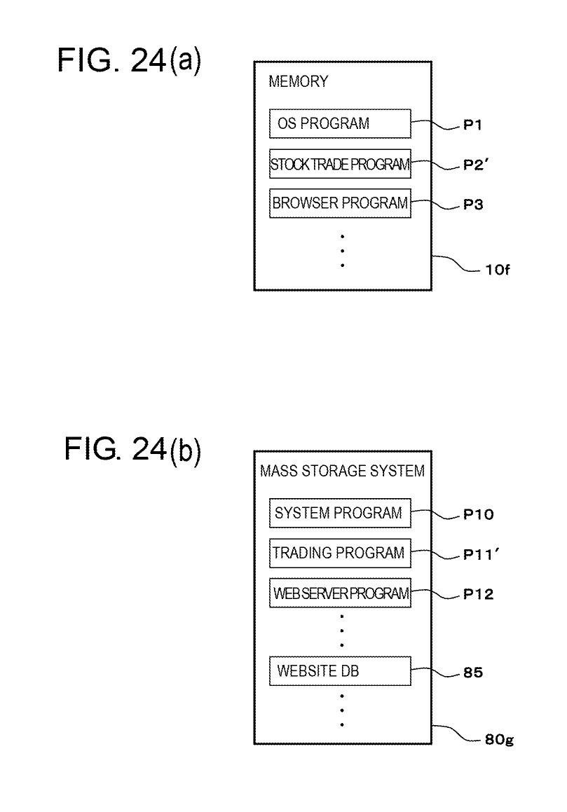

FIG. 24(a) illustrates details of programs, etc. stored in the memory 10f of the smartphone 10 (see FIG. 2) as one example of the user terminal, and a browser program P3 is newly stored as a program specific to Embodiment 2. The browser program P3 performs processing steps cooperating with a stock trade program P2′ for Embodiment 2. For example, when the stock-trade icon 12 in the home screen 11 of FIG. 3 is selected, the browser program P3 accesses to the website established by the securities company system 2, and after this access, the CPU 10a generates a webpage screen which is based on webpage data transmitted from the securities company system 2, based on processing steps defined by the browser program P3, and displays each webpage screen on the display unit 10g. Moreover, the CPU 10a also controls, based on the definition of the browser program P3, when a selecting operation of each button included in the webpage screen is received, a transmission of a notice of operation indicative of the button being selected to the securities company system 2.

FIG. 24(b) illustrates details of programs, etc. stored in the mass storage system 80g of the system server 80 of the securities company system 2. As elements specific to Embodiment 2, the mass storage system 80g newly stores a web server program P12, and also stores a website DB 85 where webpage data corresponding to a plurality of webpages which constitute websites established on the network are stored. The web server program P11 reads screen data of a necessary webpage from the website DB 85 according to an access situation from the user terminal and then transmits the screen data to the user terminal which is an accessing device, and thus, transmits the screen data according to the notice of operation which is transmitted from the user terminal which is the accessing device.

Moreover, a trading program button P11′ of Embodiment 2 is to perform processing by cooperating with the processing of the web server program P11, and details of the processing to be executed (a calculation of profit portion, buy/sell transactions based on the details of calculation, etc.) are similar to those of Embodiment 1.

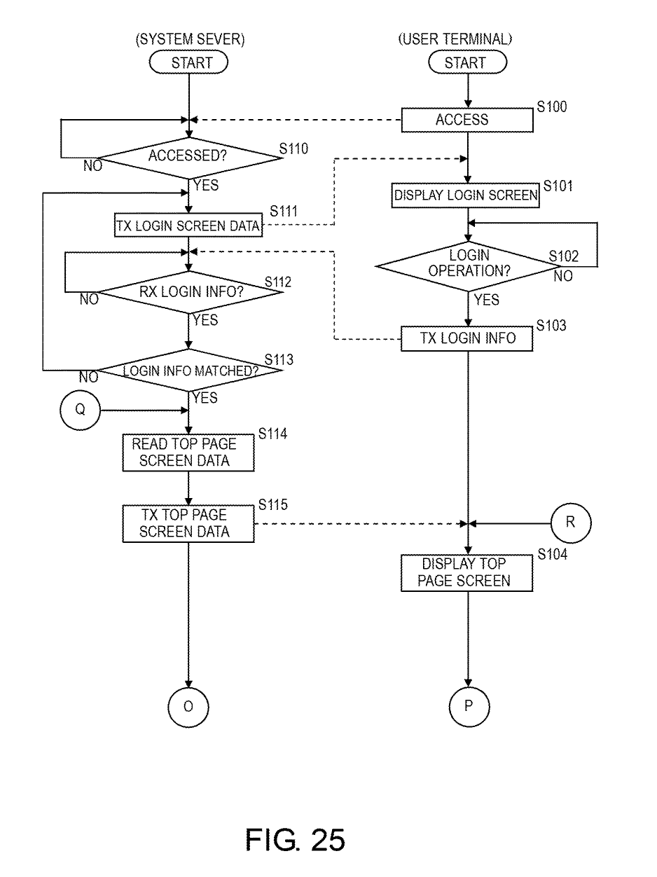

The 7th flowchart of FIG. 25 illustrates details of the method of trading the financial product related to a login processing, and corresponds to the 1st flowchart of FIG. 14 in Embodiment 1. First, in response to the selecting operation of the user of the stock-trade icon 12 on the home screen of FIG. 3 (S100), the user terminal accesses to the securities company system 2. At the first stage where the user has not logged in, the system server 80 of the securities company system 2 becomes in a state of determining the existence of access from the user terminal (S110), and if there is no access (S110: NO), it then becomes in a state of waiting for the access. On the other hand, if there is an access (S110), the system server 80 reads the screen data for login having contents similar to the login screen 15 illustrated in FIG. 4 from the website DB 85, and then transmits the screen data to the user terminal that is the accessing device (S111).

If the screen data for login is received, the user terminal displays a login screen 15 (webpage screen) having contents similar to FIG. 4 (S101), and then determines whether a login operation required for login, such as inputs of an email address and a password, etc. is received (S102). If the user terminal has not received the login operation (S102: NO), it becomes in a state of waiting for the login operation, and on the other hand, if the user terminal receives the login operation (S102: YES), it transmits login information (inputted contents, UID, etc.) to the securities company system 2 (S103).

The system server 80 of the securities company system 2 becomes at a stage of determining whether the login information has been received after the transmission of the screen data for login (S112). If the login information has not been received (S112: NO), the system server 80 becomes in a state of waiting for the reception of the login information, and on the other hand, if the login information is received (S112: YES), the system server 80 determines whether the received login information matches with the information stored in the user DB 82 of FIG. 11 (S113). If the login information is not matched (S113: NO), the system server 80 returns to step S111, where the screen data for login is again transmitted to the user terminal. In this case, the user terminal also returns to step S101, where the login screen is displayed to again offer the opportunity of login to the user.

On the other hand, if the login information is matched (S113: YES), the system server 80 reads screen data for a top page corresponding to details according to the top page screen 20 of FIG. 5 from the website DB 85 (S114), and then transmits it to the user terminal which is the accessing device (S115). The user terminal, which received the screen data for top page, generates the top page screen 20 (webpage screen) of the details according to FIG. 5 based on the received screen data, and then displays it on the display unit 10g (S104).

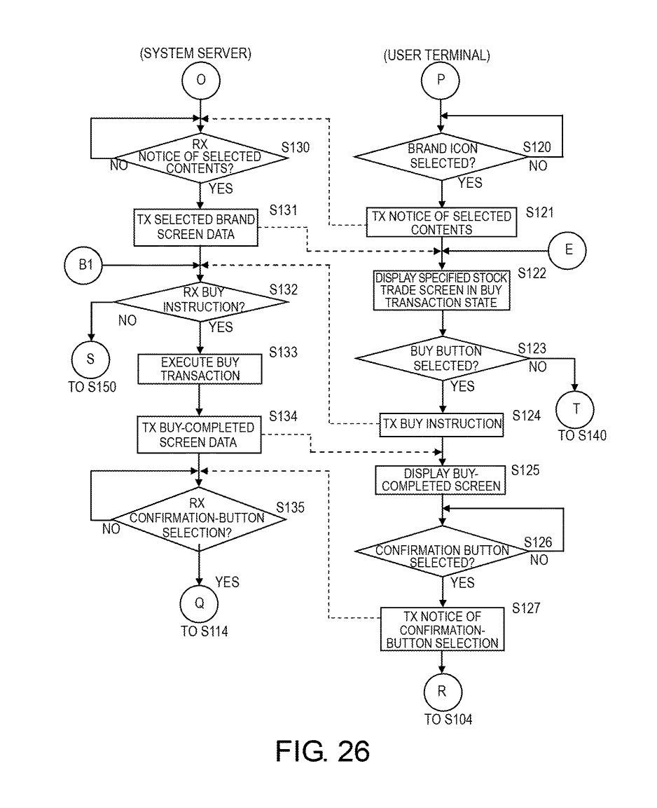

The 8th flowchart of FIG. 26 illustrates details of the method of trading the financial product related to buy transaction of stocks, and corresponds to the 2nd flowchart of FIG. 15 in Embodiment 1. First, the user terminal determines whether a selecting operation of any one of stock-trade icons 21a-21f for each company arranged in the top page screen 20 is received (S120). If the selecting operation has not been received from the user (S120: NO), the user terminal becomes in a state of waiting for the selection, and on the other hand, if the selecting operation is received (S120: YES), the user terminal transmits a notice of selected contents which notifies of the company corresponding to the selected icon, to the system server 80 (S121).

The system server 80 determines whether the notice of selected contents is received (S130). If the notice of selected contents has not been received (S130: NO), the system server 80 becomes in a state of waiting for the reception. If the notice of selected contents is received (S130: YES), the system server 80 reads screen data of a specified brand trade screen (corresponding to the specified brand trade screen 25 in the buy transaction state of FIG. 6) according to the company notified by the received notice of selected contents, from the website DB 85, and then transmits it to the user terminal which is the accessing device (S131).

The user terminal then receives the screen data described above, and displays the specified brand trade screen 25 (webpage screen) in the buy transaction state similar to FIG. 6 (S122). Then, the user terminal determines whether a money amount is set by the user in the money-amount setting field 26e of the specified brand trade screen 25 and a selecting operation of the buy button 30a is received (S123). If the selecting operation of the buy button 30a is received (S123: YES), the user terminal transmits a buy instruction containing the information for identifying the brand (a brand ID), the money-amount information indicative of the money amount set in the money-amount setting field 26e, etc., to the securities company system 2 (S124).

Moreover, the system server 80 (the MPU 80a) determines whether the buy instruction is received from the user terminal (S132), and if the buy instruction is received (S132: YES), the system server 80 identifies a stock price of the brand (the latest stock price at the time of reception) contained in the buy instruction among the brand DB 81, calculates the number of stocks which can be purchased based on the money amount contained in the buy instruction, and executes a buy bilateral transaction by a tradable unit of the number of stocks according to the calculated number of stocks (S133). Note that in association with the execution of buy transaction, details of the processing are stored in the account DB 83. The system server 80 then transmits screen data indicative of a buy-completed notice to the user terminal which is a sender of the buy instruction (S134).

The user terminal generates and displays a buy-completed screen 36 (webpage screen) according to FIG. 8(a) based on the reception of the screen data corresponding to the buy-completed notice from the securities company system 2 (S125). The user terminal then determines whether a selecting operation of the confirmation button 36a in the buy-completed screen 36 is received (S126). If the selecting operation has not been received (S126: NO), the user terminal becomes in a state of waiting for the selecting operation, and if the selecting operation is received (S126: YES), the user terminal transmits a notice of confirmation-button selection to the system server (S127).

The system server 80 determines whether the notice of confirmation-button selection is received (S135). If it has not been received (S135: NO), and the system server 80 becomes in a state of waiting for the reception, and on the other hand, if it is received (S135: YES), the system server 80 returns to step S114 in the 7th flowchart of FIG. 25, where a read-out and a transmission of the screen data according to the top page screen are performed (S115). Therefore, the user terminal side also returns to step S104 the 7th flowchart, where the top page screen 20 (webpage screen) is again displayed.

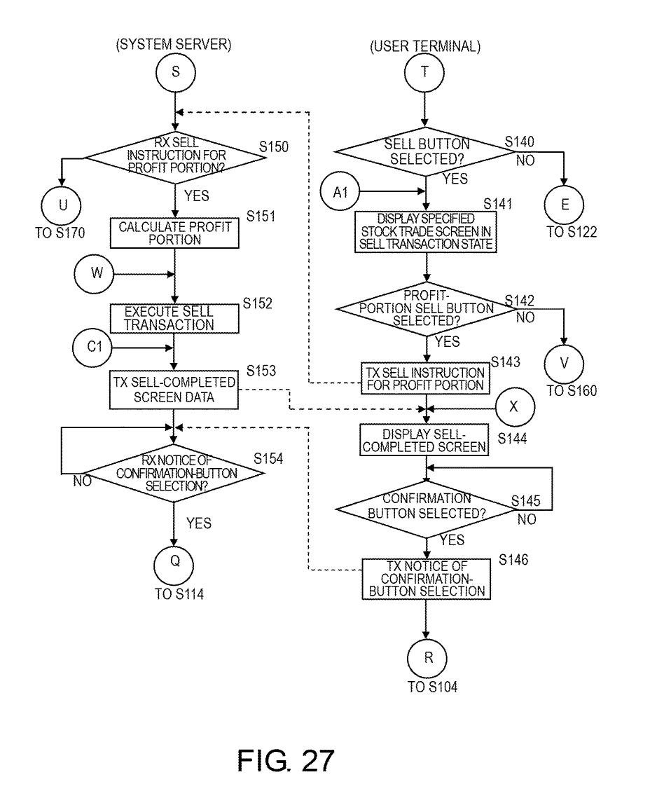

The 9th flowchart of FIG. 27 illustrates details of processing which start when the selecting operation of the buy button has not been received (S123: NO) at step S123 in the 8th flowchart of FIG. 26 described above, illustrates details of the method of trading the financial product related to sell transaction of stocks, and corresponds to the 3rd flowchart of FIG. 16 in Embodiment 1. First, the user terminal determines whether a selecting operation of the sell button 26b is received in the specified brand trade screen 25 in the buy transaction state (S140). If the selecting operation of the sell button 26b has not been received (S140: NO), the user terminal returns to step S122 in the 8th flowchart of FIG. 26, where the indication of the specified brand trade screen 25 in the buy transaction state is continued. On the other hand, if the selecting operation of the sell button 26b is received (S140: YES), the specified brand trade screen 26 in the sell transaction state is displayed (S141).

Then, the user terminal determines whether a selecting operation of the profit-portion sell button 35c in the sell transaction part 35 near the center of the screen of the specified brand trade screen 25 is received (S142). If the selecting operation of the profit-portion sell button 35c is received (S142: YES), the user terminal transmits a sell instruction for a profit portion to the securities company system 2 (S143). The system server 80 of the securities company system 2 determines whether the sell instruction for a profit portion is received (S150), and if determined that the sell instruction for a profit portion is received (S150: YES), the system server 80 calculates a profit portion similar to step S51 in the 3rd flowchart of FIG. 16 (S151), and executes a sell bilateral transaction similar to step S52 of the 3rd flowchart (S152). Note that in association with the execution of sell transaction, details of the processing are stored in the account DB 83.

Then, the system server 80 reads the screen data according to the sell-completed notice from the web site DB 85 and transmits it to the user terminal (S153). The user terminal displays a sell-completed screen 37 (webpage screen) of details according to FIG. 8(b) in response to a reception of the screen data (S144). Then, the user terminal determines whether a selecting operation of the confirmation button 37a in the sell-completed screen 37 is received (S145). If the selecting operation has not been received (S145: NO), the user terminal becomes in a state of waiting for the selecting operation, and on the other hand, if the selecting operation is received (S145: YES), the user terminal transmits a notice of confirmation-button selection to the system server (S146).

The system server 80 determines whether the notice of confirmation-button selection is received (S154). If the notice has not been received (S154: NO), and the system server 80 becomes in a state of waiting for the reception, and on the other hand, if it is received (S154), the system server 80 returns to step S114 in the 7th flowchart of FIG. 25, where a read-out and a transmission of screen data according to the top page screen are performed (S115). Consequently, the user terminal side also returns to step S104 of the 7th flowchart, where the top page screen 20 (webpage screen) is again displayed.

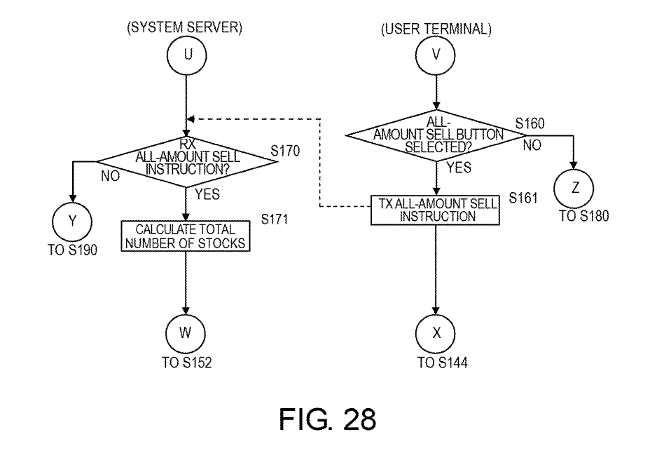

The 10th flowchart of FIG. 28 illustrates details of the processing which starts when the selecting operation of the profit-portion sell button 35c has not been received (S142: NO) at step S142 in the 9th flowchart of FIG. 27 described above, and corresponds to the 4th flowchart of FIG. 17 in Embodiment 1. Note that the system server 80 side in the 10th flowchart of FIG. 28 starts processing of the 10th flowchart when the sell instruction for a profit portion has not been received (S150: NO) at step S150 in the 9th flowchart of FIG. 27.

In the 10th flowchart, the user terminal first determines whether a selecting operation of the all-amount sell button 35b in the sell transaction part 35 near the center of the screen of the specified brand trade screen 25 is received (S160). If the selecting operation of the all-amount sell button 35b is received (S160: YES), the user terminal transmits an all-amount sell instruction (including a brand ID of the brand according to the specified brand trade screen 25) to the securities company system 2 (S161).

The system server 80 of the securities company system 2 determines whether the all-amount sell instruction is received (S170), and if the system server 80 determines that the all-amount sell instruction is received (S170: YES), it calculates the total number of stocks similar to the case of step S71 in the 4th flowchart of FIG. 17 (S171). Subsequent processing is equivalent to the processing at and after step S152 in the 9th flowchart of FIG. 27, where a series of processing steps including a sell transaction of the calculated total number of stocks is performed. Processing steps on the user terminal side are also equivalent to the processing steps at and after step S144 in the 9th flowchart of FIG. 27 after the transmission of all-amount sell instruction (after S161).

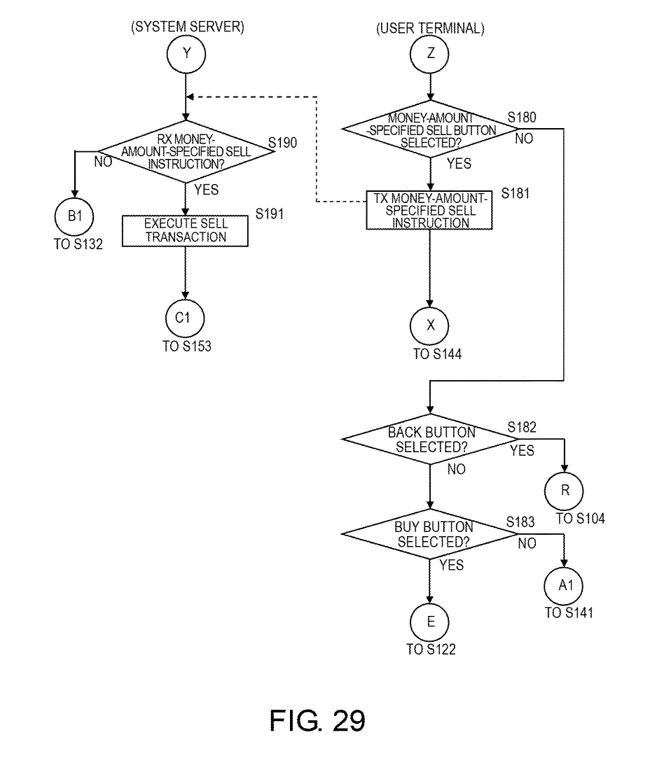

The 11th flowchart of FIG. 29 illustrates details of the processing which starts when the selecting operation of the all-amount sell button 35b has not been received (S160: NO) at step S160 in the 10th flowchart of FIG. 28 described above, and corresponds to the 5th flowchart of FIG. 18 in Embodiment 1. Note that the system server 80 side in the 11th flowchart of FIG. 29 starts the processing of the 11th flowchart when all-amount sell instruction has not been received (S170: NO) at step S170 in the 10th flowchart of FIG. 28.

The user terminal determines whether a money amount is set by the user in the money-amount setting field 26e of the specified brand trade screen 25, and a selecting operation of the money-amount-specified sell button 35a in the sell transaction part 35 near the center of the screen is received (S180). If the selecting operation of the money-amount-specified sell button 35a is received (S180: YES), the user terminal transmits a money-amount-specified sell instruction to the securities company system 2 (S181). The system server 80 determines whether the money-amount-specified sell instruction is received (S190). If the system server 80 determines that the money-amount-specified sell instruction is received (S190: YES), it performs a sell transaction similar to that at step S76 in the 5th flowchart of FIG. 18 (S191). Subsequent processing steps are equivalent to the processing steps at and after step S153 in the 9th flowchart of FIG. 27, and subsequent processing steps on the user terminal side are also equivalent to the processing steps at and after step S144 of the 9th flowchart.

On the other hand, if the selecting operation of the money-amount-specified sell button 35a is not performed at the step S180 (S180: NO), the user terminal determines whether a selecting operation of the back button 25g in the specified brand trade screen 25 of FIG. 7 is received (S182). If the selecting operation of the back button 25g has not been received (S182: NO), the user terminal determines whether a selecting operation of the buy button 26a is received (S183). If the selecting operation of the buy button 26b has not been received (S183: NO), the user terminal returns the processing to step S141 in the 9th flowchart of FIG. 27 (the display stage of the specified brand trade screen 25 in the sell transaction state). If the selecting operation of the buy button 26b is received (S183: YES), the user terminal returns the process to step S122 in the 8th flowchart of FIG. 26 (the display stage of the specified brand trade screen 25 in the buy transaction state). Further, if the selecting operation of the back button 25g is received (S182: YES), the user terminal returns the process to step S104 in the 7th flowchart of FIG. 25 (the display stage of the top page screen 20). Note that if the money-amount-specified sell instruction has not been received at step S190 on the system server side (S190: NO), the system server side returns the process to step S132 in the 8th flowchart of FIG. 26.

Thus, the invention according to Embodiment 2 is configured to perform the details according to Embodiment 1 on a website basis. By the invention according to Embodiment 2, the details of the processing of the financial product transaction of the present invention can be performed with a flexible system configuration. Note that also in Embodiment 2, the details of the various modifications described in Embodiment 1 are applicable by details adapted to Embodiment 2.

### Embodiment 3

The financial product trading system according to Embodiment 3 of the present invention has a feature in that the details of the processing which are performed on the system server 80 side, such as the calculation for the profit portion in the details according to Embodiment 1 described above are performed on the user terminal side. Therefore, the system server 80 side can address the processing with the conventional configuration for processing by the unit number of stocks. Note that also in Embodiment 3, since details of various screens displayed on the user terminal side are similar to those of Embodiment 1, and hardware configuration is also similar to that of Embodiment 1, details of Embodiment 3 are described below using the same reference numerals as those of Embodiment 1.

In Embodiment 3, the stock trading application P2 (see FIG. 2) stored in the memory 10f of the user terminal (e.g., the smartphone 10) defines that the user terminal also performs the details of the processing performed by the system server 80 in Embodiment 1 (e.g., the calculation of the profit portion at step S51 in the 3rd flowchart of FIG. 16), in addition to the details of the processing in Embodiment 1 described above. According to such a definition of the stock trading application P2, the CPU 10a of the user terminal functions as a calculation processor configured to calculate the profit portion, and calculating the tradable range of the number of stocks based on the calculated profit portion, etc.

In order to perform on the user terminal side the calculation for the profit portion, the calculation of the tradable range of the number of stocks based on the calculated profit portion, etc., the user terminal receives and acquires the latest stock price, etc. (a unit price of the financial product) of each brand from the system server 80 whenever necessary, and receives information required for transaction (transaction data indicative of transaction details of the financial product corresponding to the brand, etc.) from the system server 80 among the contents stored in the user account table of the user, and stores the information in the memory 10f.

On the other hand, the system server 80 side of the securities company system 2 does not perform the calculation for the profit portion, the calculation of the tradable range of the number of stocks based on the calculated profit portion, etc. which are performed in Embodiment 1, but performs buy/sell transaction according to a trade instruction (buy/sell instruction) with the number of stocks of the brand being specified which is transmitted from the user terminal side. Note that the system server 80 transmits a latest stock price, etc. of each brand to the logged-in user terminal at a given time interval, and transmits details (transaction data indicative of details of transaction of the financial product corresponding to the brand) stored in the user account table corresponding to the logged-in user, to the user terminal of the user.

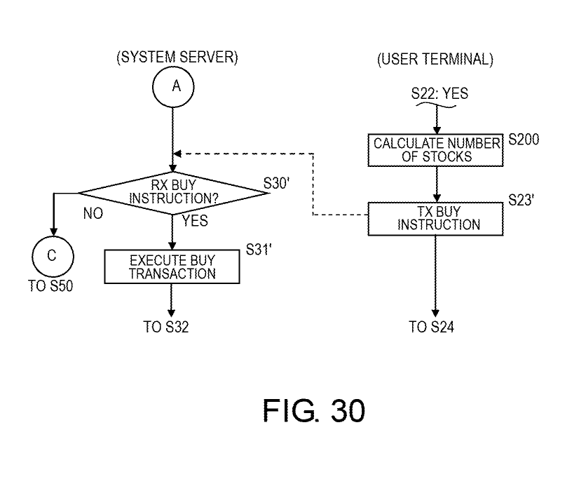

The 12th flowchart of FIG. 30 illustrates details of the buy transaction of Embodiment 3 corresponding to the 2nd flowchart of FIG. 15. The 12th flowchart of FIG. 30 illustrates processing after the buy button 30a is selected in the specified brand trade screen 25 in the buy transaction state of FIG. 6 in the 2nd flowchart of FIG. 15 (S22: YES), and the user terminal divides the money amount set in the money-amount setting field 26e by the latest stock price stored in the memory 10f to calculate the purchasable number of stocks (S200). The user terminal then transmits a buy instruction containing number-of-stocks information indicative of the calculated number of stocks, to the securities company system 2 (S23′).

The system server 80 of the securities company system 2 determines whether the buy instruction containing the number-of-stocks information is received (S30′) and if received (S30′: YES), the system server 80 executes, based on the number-of-stocks information contained in the received buy instruction, buy transaction by the purchasable number of stocks corresponding to the number of stocks indicated by the number-of-stocks information (S31′). Comparing the processings on the system server 80 side with the processing of the 2nd flowchart of FIG. 15, they are different in that the received number-of-stocks information is not included in the buy instruction at step S30 but the number-of-stocks information is included at the step S30′, and the number of stocks is necessary to be calculated from the money amount setting at the step S31 but such a calculation of the number of stocks is unnecessary at the step S31′.

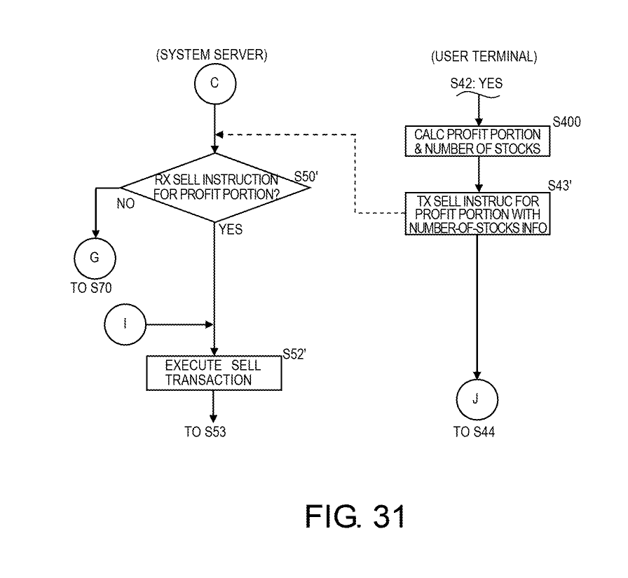

The 13th flowchart of FIG. 31 illustrates details of a sell transaction for the profit portion of Embodiment 3 corresponding to the 3rd flowchart of FIG. 16. The 13th flowchart of FIG. 31 illustrates processing after the profit-portion sell button 35c is selected in the specified brand trade screen 25 in the sell transaction state of FIG. 7 in the 2nd flowchart of FIG. 16 (S42: YES), and the user terminal reads out the stored information on the stock price (a unit price) for the particular brand of stocks corresponding to the currently-displayed specified brand trade screen 25 from the memory 10f, also reads out the transaction data of the particular brand of stocks from the memory 10f, calculates the profit portion of the particular brand of stocks based on the stock price and the transaction data, and divides the money amount of the calculated profit portion by the latest stock price stored in the memory 10f to calculate the purchasable number of stocks (S400). Then, the user terminal transmits a sell instruction for a profit portion containing the number-of-stocks information indicative of the calculated number of stocks, to the securities company system 2 (S43′).

The system server 80 of the securities company system 2 determines whether the sell instruction for a profit portion containing the number-of-stocks information is received (S50′), and if received (S50′: YES), the system server 80 executes a sell transaction by the purchasable number of stocks corresponding to the number of stocks indicated by the number-of-stocks information based on the received number-of-stocks information contained in the sell instruction (S52′). Comparing the processing on the system server 80 side with the processing of the 3rd flowchart of FIG. 16, they are different in that the number-of-stocks information is not included in the received sell instruction at step S50 but the number-of-stocks information is included at step S50′. Moreover, they are different in that the calculation of the profit portion at step S51 does not exist in the 13th flowchart of FIG. 31, and further, the calculation of the number of stocks from the profit portion is necessary at step S52 but such a calculation of the number of stocks is unnecessary at step S52′.

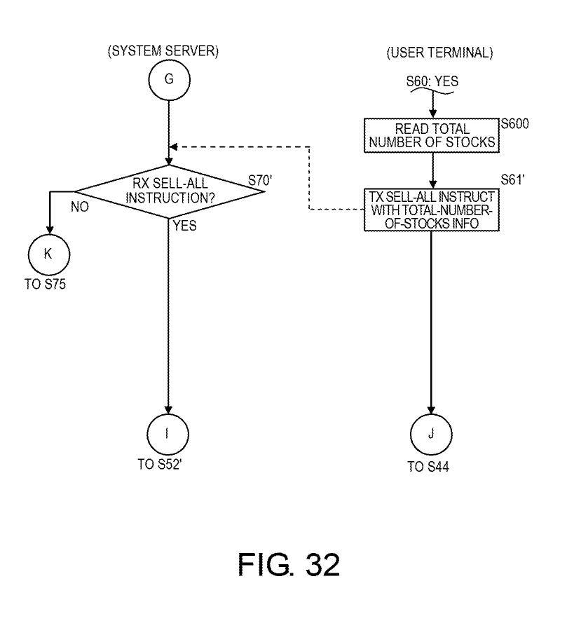

The 14th flowchart of FIG. 32 illustrates details of the sell-all-amount transaction of Embodiment 3 corresponding to the 4th flowchart of FIG. 17. The 14th flowchart of FIG. 32 illustrates the processing after the all-amount sell button 35b is selected in the specified brand trade screen 25 in the sell transaction state of FIG. 7 in the 4th flowchart of FIG. 17 (S60: YES), and the user terminal reads out from the memory 10f and identifies the total number of stocks being corresponding to the specified brand trade screen 25 that is currently-displayed (S600). And then the user terminal transmits a sell instruction containing total-number-of-stocks information indicative of the possessed total number of stocks that is identified to the securities company system 2 (S61).

The system server 80 of the securities company system 2 determines whether the sell instruction containing the total-number-of-stocks information is received (S70′), and if received (S70′: YES), the system server 80 executes a sell transaction by the purchasable number of stocks corresponding to the number of stocks indicated by the total-number-of-stocks information based on the total-number-of-stocks information contained in the received sell instruction (S52′).

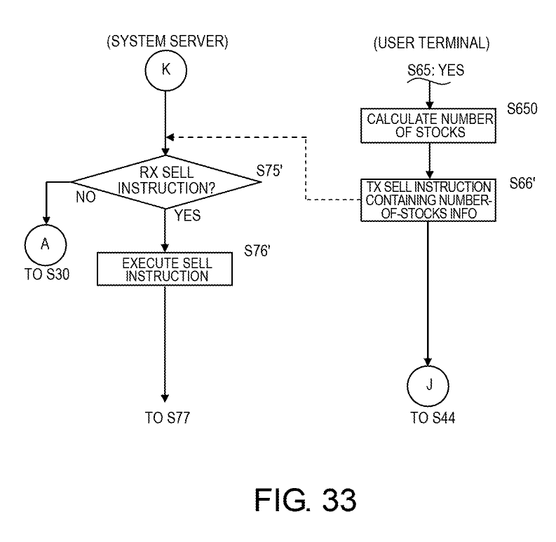

The 15th flowchart of FIG. 33 illustrates details of the sell-all-amount transaction of Embodiment 3 corresponding to the 5th flowchart of FIG. 18. The 15th flowchart of FIG. 33 illustrates processing after the money-amount-specified sell button 35a is selected in the specified brand trade screen 25 in the sell transaction state of FIG. 7 in the 5th flowchart of FIG. 18 (S65: YES), and the user terminal divides the money amount set in the money-amount setting field 26e by the latest stock price stored in the memory 10f to calculate the sellable number of stocks (S650). Then, the user terminal transmits a sell instruction containing the number-of-stocks information indicative of the calculated number of stocks to the securities company system 2 (S66′).

The system server 80 of the securities company system 2 determines whether the sell instruction containing number-of-stocks information is received (S75′), and if received (S75′: YES), the system server 80 executes a sell transaction by the sellable number of stocks corresponding to the number of stocks indicated by the number-of-stocks information based on the number-of-stocks information contained in the received sell instruction (S76′).

Thus, in Embodiment 3, since the user terminal transmits the buy/sell instruction containing the number-of-stocks information indicative of the number of stocks to the securities company system 2 in any one of the cases including the buy transaction and the three patterns of sell transactions, it is advantageous in that the system server 80 side of the securities company system 2 becomes unnecessary to calculate the number of stocks based on the money amount, etc., and the processing can be proceeded based on the unit number of stocks. Note that the various modifications described in Embodiment 1 are also applicable to Embodiment 3.

### Embodiment 4

The financial product trading system according to Embodiment 4 of the present invention does not use the transaction screen (e.g., the specified brand trade screen 25 illustrated in FIGS. 6 and 7) only dedicated to stocks of one particular brand (e.g., Company A) in Embodiment 1, etc. described above, but presents a transaction screen where a brand is selectable so that the user can give a transaction instruction with one-touch operation. Note that since a hardware configuration of Embodiment 4 is also similar to that of Embodiment 1, details of Embodiment 4 are described below using the same reference numerals as those of Embodiment 1.

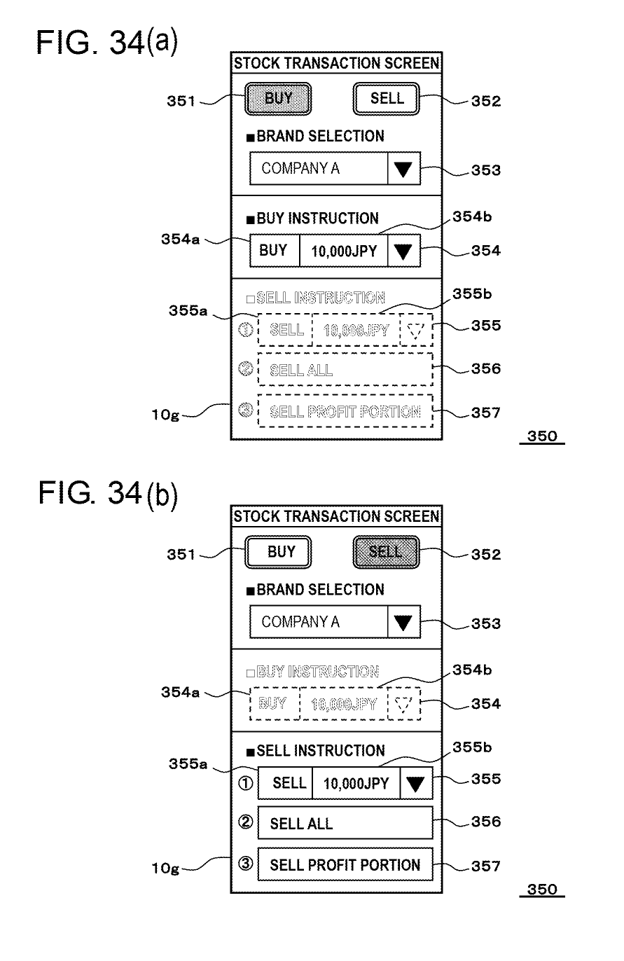

FIGS. 34(a) and (b) illustrate a transaction screen 350 for trading stocks according to Embodiment 4, which is displayed on the display unit 10g of a communication terminal on the user side (the smartphone 10). FIG. 34(a) illustrates the transaction screen 350 in a buy transaction state (corresponding to the specified brand trade screen 25 in the buy transaction state of Embodiment 1 in FIG. 6), and FIG. 34(b) illustrates the transaction screen 350 in a sell transaction state (corresponding to the specified brand trade screen 25 in the sell transaction state of Embodiment 1 in FIG. 7).

In the transaction screen 350, a buy button 351 and a sell button 352, which are receivable of a selecting operation, are arranged on an upper side of the screen. These buttons 351 and 352 correspond to the buy button 26a and the sell button 26b in the specified brand trade screen 25 of Embodiment 1, respectively. When the buy button 351 is selected, the transaction screen 350 becomes into the buy transaction state as illustrated in FIG. 34(a), and on the other hand, when the sell button 352 is selected, the transaction screen 350 becomes into the sell transaction state as illustrated in FIG. 34(b). Note that in the transaction screen 350 in the buy transaction state, the sell button 352 changes to a selectable state, and on the other hand, in the transaction screen 350 in the sell transaction state, the buy button 351 changes to a selectable state, so that the buttons 351 and 352 are alternately selectable to suitably switch the buy transaction state and the sell transaction state.

In the transaction screen 350, a brand selection field 353 is arranged below the buy button 351 and the sell button 352. The brand selection field 353 is to select and specify one particular brand of stocks (e.g., Company A) which the user desires to trade, from the plurality of brands (e.g., Company A, Company B, Company C, etc.). Note that the tradable range of brands may be extracted beforehand by the securities company side which provides the stock trading service, or without particularly extracting the brands, a wide range of tradable stocks may be configured to be selectable.

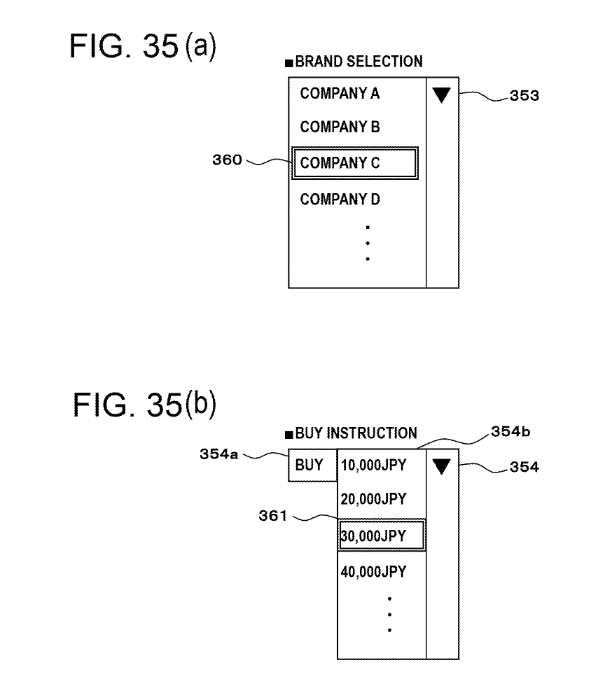

FIG. 35(a) illustrates the brand selection field 353 in a developed state in response to the user touching the screen surface of the display unit 10g corresponding to the brand selection field 353. In the brand selection field 353 in the developed state, the field spreads downwardly and notations of the brands to be selected (Company A, Company B, Company C, etc.) are indicated, and a cursor 360 appears. The cursor 360 is movable by a user operation in the vertical directions on the screen of the display unit 10g, and a brand which is surrounded by the cursor 360 is a brand which is selected and specified by the user (FIG. 35(a) illustrates a state where Company C is selected and specified).

In addition, in the transaction screen 350, a buy transaction setting part 354 is provided below the brand selection field 353. In the buy transaction setting part 354, a buy button 354a is arranged on the left side, and a money-amount setting field 354b is arranged on the right side thereof. Note that the buy transaction setting part 354 becomes operable (becomes in an active state) in the buy transaction state illustrated in FIG. 34(a), and inoperable (inactive state) in the sell transaction state illustrated in FIG. 34(b).

The left buy button 354a corresponds to the buy button 30a in the specified brand trade screen 25 of Embodiment 1. When the buy button 354a receives a selecting operation of the user, the CPU 10a transmits a buy instruction (a buy order) of the money-amount part set in the right money-amount setting field 354b for one particular brand of stocks specified in the brand selection field 353 described above, to the securities company system 2.

FIG. 35(b) illustrates a state where the money-amount setting field 354b of the buy transaction setting part 354 is developed. Similar to the brand selection field 353 illustrated in FIG. 35(a), the money-amount setting field 354b is developed in response to the user touching the screen surface of the display unit 10g corresponding to the money-amount setting field 354b. In the money-amount setting field 354b in the developed state, the field spreads downwardly and notations of the money amounts to be set (notations of the money amounts by the units of tens of thousands of Yen, such as 10,000 JPY, 20,000 JPY, and 30,000 JPY), and a cursor 361 appears. The cursor 360 is movable in the vertical directions on the screen of the display unit 10g by a user operation, and a notation of the money amount surrounded by the cursor 361 is a money amount set by the user (FIG. 35(b) illustrates a state where 30,000 JPY is set).

In addition, as illustrated in FIG. 34(b), in the transaction screen 350, a sell transaction field is provided below the buy transaction setting part 354, and this sell transaction field includes a sell transaction setting part 355, an all-amount sell button 356, and a profit-portion sell button 357. Note that the sell transaction setting part 355, the all-amount sell button 356, and the profit-portion sell button 357 in the sell transaction field become operable in the sell transaction state illustrated in FIG. 34(b) (becomes in an active state), and become inoperable in the buy transaction state (inactive state) illustrated in FIG. 34(a).

The sell transaction setting part 355 has a similar configuration to the buy transaction setting part 354 described above, where a sell button 355a is arranged on the left side, and a money-amount setting field 355b is arranged to the right thereof. The left sell button 355a corresponds to the money-amount-specified sell button 35a in the specified brand trade screen 25 of Embodiment 1. When the sell button 355a receives a selecting operation of the user, the CPU 10a transmits a sell instruction (sell order) of the money-amount part set in the right money-amount setting field 355b for one particular brand of stocks specified in the brand selection field 353 described above, to the securities company system 2. Note that the right money-amount setting field 355b is configured to be settable of the money amount by which the user desires to trade, similar to the money-amount setting field 354b illustrated in FIG. 35(b).

When the all-amount sell button 356 below the sell transaction setting part 355 corresponds to the all-amount sell button 35b in the specified brand trade screen 25 of Embodiment 1. When a selecting operation of the user is received, the CPU 10a transmits a sell instruction for all the stocks (all stocks of Company A in FIG. 34(b)) which are possessed by the logged-in user, for one particular brand of stocks specified in the brand selection field 353 described above, to the securities company system 2.

The profit sell button 357 below the sell button 356 corresponds to the profit-portion sell button 35c in the specified brand trade screen 25 of Embodiment 1. When a selecting operation of the user is received, the CPU 10a transmits a sell instruction for the profit portion resulted from the stocks possessed by the logged-in user (the profit portion of the stocks of Company A in FIG. 34(b)) for one particular brand of stocks specified in the brand selection field 353 described above, to the securities company system 2.

Such a transaction screen 350 according to Embodiment 4 is applicable to any of the system and method for trading the financial product in Embodiments 1-3 described above. If it is applied to the configuration corresponding to Embodiment 1, for example, it may be desirable to be configured so that, when the stock-trade icon 12 is selected in the home screen 11 illustrated in FIG. 3, the transaction screen 350 is then displayed via the login processing in the login screen 15 illustrated in FIG. 4. Moreover, if it is applied to the configuration corresponding to Embodiment 2 of the webpage basis, for example, it may be suitable to be configured so that, when the website distributed by the securities company system 2 is accessed, the transaction screen 350 is displayed via the login processing in the login screen.

Note that Embodiment 4 is similar in the details to Embodiments 1-3 other than those described above, and the various modifications described in Embodiment 1 are also applicable thereto. Thus, in the transaction screen 350 of Embodiment 4, since the selection of the brand is also possible in the same screen for giving the trading instructions, it is suitable to the user who gives the trading instructions while frequently changing the brand.

### INDUSTRIAL APPLICABILITY

Since the present invention allows the investor to send the sell instruction for the profit portion resulted from stocks with one-touch operation, it is suitably utilized for quickly selling the stocks.

### DESCRIPTION OF REFERENCE CHARACTERS

1 Financial Product Trading System
2 Securities Company System
3 Information Collecting System
4 Exchange System
10 Smartphone
10a CPU
11 Home Screen
12 Stock-trade Icon
20 Top Page Screen
21a-21f Stock-trade Icons for Companies A to F
25, 250 Specified Brand Trade Screen
26 First Common Part
26a Buy Trade Button
26b Sell Button
26e Money-amount Setting Field
27a Average Buy Unit Price Field
27b Current Stock Price Field
27c Total Investment Amount Field
27d Current Market Value Field
30a Buy Button
35a Money-amount-specified Sell Button
35b All-amount Sell Button
35c Profit-portion Sell Button
80 System Server
80a MPU
81 Brand DB
82 User DB
83 Account DB
350 Transaction Screen
P1 Stock Trade Program
P11 Trading Program
T1-T3 User Terminal
U1-U3 User (Investor)

1. A financial product trading system, where a communication terminal transmits a trade instruction of a financial product to a server based on a user operation, and the server performs a transaction of the financial product in response to a reception of the trade instruction from the communication terminal,
the communication terminal comprising:
a displaying means for displaying a transaction screen containing a sell-for-profit-portion operating part receivable of a user operation corresponding to a sell instruction for a profit portion resulted from the financial product of one particular brand; and
a transmitting means for transmitting the sell instruction for the profit portion resulted from the financial product of the one particular brand to the server, when the user operation is received by the sell-for-profit-portion operating part, and
the server comprising:
a trade history database configured to store a trade history of the financial product;
an identifying means for identifying, when the sell instruction for the profit portion resulted from the financial product of one particular brand is received, a unit price of the financial product of the one particular brand at the moment of reception;
a calculating means for calculating the profit portion resulted from the financial product of the one particular brand based on the trade history of the financial product of the one brand stored in the trade history database and the identified unit price; and
a transacting means for performing a sell transaction for the calculated profit portion.

2. The financial product trading system of claim 1, wherein the transaction screen is a screen dedicated to the transaction of the one particular brand.

3-19. (canceled)

20. The financial product trading system of claim 2, wherein the displaying means is configured to:
display an icon screen containing selectable icons corresponding to a plurality of brands in the same screen, the plurality of brands being extracted beforehand, and
display, when a selection of one icon among the plurality of icons contained in the displayed icon screen is received, the transaction screen as a screen dedicated to a transaction of the one brand corresponding to the icon that received the selection.

21. A method of trading a financial product, where a communication terminal transmits a trade instruction of a financial product to a server based on a user operation, and the server performs a transaction of the financial product in response to a reception of the trade instruction from the communication terminal,
the communication terminal performing the steps of:
displaying a transaction screen containing a sell-for-profit-portion operating part receivable of a user operation corresponding to a sell instruction for a profit portion resulted from the financial product of one particular brand; and
transmitting the sell instruction for the profit portion resulted from the financial product of one particular brand to the server, when the user operation is received by the sell-for-profit-portion operating part, and
the server performing the steps of:
a trade history database configured to store a trade history of the financial product;
identifying, when the sell instruction for the profit portion resulted from the financial product of one particular brand is received, a unit price of the financial product of the one particular brand at the moment of reception;
calculating the profit portion resulted from the financial product of the one particular brand based on the trade history of the financial product of the one brand stored in the trade history database and the identified unit price; and
performing a sell transaction for the calculated profit portion.

22. The method of trading a financial product of claim 21, wherein the transaction screen is a screen dedicated to the transaction of the one particular brand.

23. The method of trading a financial product of claim 22, wherein the communication terminal performs the steps of:
displaying an icon screen containing selectable icons corresponding to a plurality of brands in the same screen, the plurality of brands being extracted beforehand; and
displaying, when a selection of one icon among the plurality of icons contained in the displayed icon screen is received, the transaction screen as a screen dedicated to a transaction of the one brand corresponding to the icon that received the selection.

24. A server configured to perform a transaction of a financial product in response to a reception of a trade instruction of the financial product transmitted from an external communication terminal, comprising:
a trade history database configured to store a trade history of the financial product;
an identifying means for identifying, when the sell instruction for a profit portion resulted from the financial product of one particular brand is received from the external communication terminal, a unit price of the financial product of the one particular brand at the moment of reception;
a calculating means for calculating the profit portion resulted from the financial product of the one particular brand based on the trade history of the financial product of the one brand stored in the trade history database and the identified unit price; and
a transacting means for performing a sell transaction for the calculated profit portion.

25. A method of trading a financial product, where a server performs a transaction of the financial product in response to a reception of a trade instruction of the financial product transmitted from an external communication terminal, the server with a trade history database configured to store a trade history of the financial product, comprising:
identifying, when the sell instruction for a profit portion resulted from the financial product of one particular brand is received from the external communication terminal, a unit price of the financial product of the one particular brand at the moment of reception;
calculating the profit portion resulted from the financial product of the one particular brand based on the trade history of the financial product of the one brand stored in the trade history database and the identified unit price; and
performing a sell transaction for the calculated profit portion.
